(19) United States
(12) Patent Application Publication
(10) Pub. No.: US 2026/0370978 A1
(43) Pub. Date: Nov. 19, 2026

(54) OPTICAL DEVICE AND METHOD FOR OPERATING AN OPTICAL DEVICE

(71) Applicant: Sony Semiconductor Solutions Corporation, Atsugi-shi, Kanagawa (JP)

(72) Inventors: Diederik Paul MOEYS, Stuttgart (DE); Gregory David BURMAN, Stuttgart (DE); Antonio VITALE, Stuttgart (DE)

(73) Assignee: Sony Semiconductor Solutions Corporation, Atsugi-shi, Kanagawa (JP)

(21) Appl. No.: 19/515,811

(22) PCT Filed: Aug. 27, 2024
(86) PCT No.: PCT/EP2024/073916

§ 371 Date: Mar. 3, 2026

(30) Foreign Application Priority Data
Sep. 14, 2023 (EP) 23197339.7

(51) Int. Cl. H04N 25/773

(52) U.S. Cl. CPC H04N 25/773

(57) ABSTRACT

An optical device comprises a plurality of pixels each configured to receive light and perform photoelectric conversion via a single photon avalanche diode, SPAD, to generate an electrical signal, circuitry configured to generate image data from the electrical signals based on imaging parameters that are adjustable for each pixel, and a control unit that is configured to divide for each of a series of specific time periods the plurality of pixels into at least a first subset of pixels and a second subset of pixels, to set for each specific time period to the pixels of each subset a different parameter value of at least one of the imaging parameters, and to carry out predetermined processing by using the image data obtained via the at least two subsets of pixels during the respective specific time period.

### FIELD OF THE INVENTION

The present disclosure relates to an optical device and a method for operation an optical device, in particular, to an optical device and a method for operating a sensor device that allows reducing the amount of data produced by an array of single photon avalanche diodes.

### BACKGROUND

As one of optical elements configured to photoelectrically convert received light into an electric signal and output the electric signal, a single photon avalanche diode (hereinafter referred to as a SPAD) that uses avalanche multiplication is known. The avalanche multiplication refers to a phenomenon in which an electron and a hole generated by incidence of a photon are accelerated by a high electric field, and a new electron and a hole are generated one after another. Because a set of an electron and a hole is increased many times and a large current flows, the SPAD using this has an advantage that weak light can be detected.

However, SPADs produce enormous amount of data (bitplanes containing 0/1 detections of single photons). For an SPAD the probability of detecting photons is directly related to the length of the pixel's exposure time. Selecting the exposure times such as to fit to the illumination conditions is a requirement for obtaining high quality images and/or high quality image data that can be used as input for further processing steps. In bright scenes a shorter exposure time is desired in order to avoid saturation while in low light condition a longer exposure time allows to accumulate more light. Adapting the exposure times is also important when imaging high-speed moving objects, as larger exposure times will induce larger motion blur artefacts.

However, the sensor parameters allowing to change the characteristics of the sensor are usually fixed or following the input from a fixed predetermined pattern. This gives suboptimal resulting data, not only with respect to the image quality, but also with respect to the amount of (redundant) data that is generated.

An improved optical device that uses SPADs and a method for operating such an optical device, which mitigate the above problems is therefore desired.

### SUMMARY OF THE INVENTION

To this end, an optical device is provided that comprises a plurality of pixels each configured to receive light and perform photoelectric conversion to generate an electrical signal via a single photon avalanche diode, SPAD, circuitry configured to generate image data from the electrical signals based on imaging parameters that are adjustable for each pixel, and a control unit. Here, the control unit is configured to divide for each of a series of specific time periods the plurality of pixels into at least a first subset of pixels and a second subset of pixels, to set for each specific time period to the pixels of each subset a different parameter value of at least one of the imaging parameters, and to carry out predetermined processing by using the image data obtained via the at least two subsets of pixels during the respective specific time period.

Further, a method for operating the optical device comprises: receiving light and performing photoelectric conversion with a plurality of pixels of the optical device to generate an electrical signal via a single photon avalanche diode, SPAD; generating with circuitry of the optical device image data from the electrical signals based on imaging parameters that are adjustable for each pixel; dividing for each of a series of specific time periods the plurality of pixels into at least a first subset of pixels and a second subset of pixels; setting for each specific time period to the pixels of each subset a different parameter value of at least one of the imaging parameters; and carrying out predetermined processing by using the image data obtained via the at least two subsets of pixels during the respective specific time period.

By using different parameter values at different pixels, it is possible to generate with a single set of a plurality of pixels different image data on a scene that can be optimized for different capturing conditions. These image data can then be combined for a predetermined task such as e.g. generation of a final image that looks as if captured with all capturing conditions optimized. By newly dividing the pixels into different subsets within each of a series of specific time periods the optimized capturing conditions for the single pixels vary with time. This ensures that a reconstruction of a video stream based on the full image data is possible, although each subset of pixels only includes a part of the pixels. In this manner, the quality of data obtained by a single sensor can be improved such as to be optimal for the intended predetermined processing/task, since a larger part of information that could in principle be captured is made available. Moreover, varying the imaging parameters can be used to find out parameter selections where the SPADs generate only a reduced data amount. Thus, the output of the predetermined processing can be improved while at the same time the data amount is reduced.

### BRIEF DESCRIPTION OF DRAWINGS

FIG. 1 is a block diagram illustrating a schematic configuration example of an electronic apparatus to which an optical device is applied.

FIG. 2 is a block diagram illustrating a schematic configuration example of the optical device.

FIG. 3A is a block diagram illustrating an example of a schematic configuration of a pixel of the optical device.

FIG. 3B is a block diagram illustrating another example of the schematic configuration of the pixel of the optical device.

FIG. 3C is a graph schematically illustrating a change in cathode potential when one photon is incident on a photodiode of the pixel of the optical device.

FIG. 3D is a graph schematically illustrating voltage-current characteristics of the photodiode of an image pixel of the optical device.

FIG. 4A is a block diagram illustrating a schematic configuration example of an optical device.

FIG. 4B is a block diagram illustrating a schematic configuration example of a pixel in a pixel array unit of the optical device.

FIG. 5A is a graph schematically illustrating a change in a cathode voltage when one photon is incident on a single photon avalanche diode included in the pixel of the pixel array unit of the optical device.

FIG. 5B is a diagram for explaining operation of the pixel of the optical device.

FIG. 5C is a diagram for explaining the operation of the pixel of the optical device.

FIG. 5D is a diagram for explaining the operation of the pixel of the optical device.

FIG. 5E is a diagram for explaining the operation of the pixel of the optical device.

FIG. 6 is a schematic diagram showing an example of a configuration of an optical device.

FIG. 7 is a plan view showing an example configuration of a light-receiving chip.

FIG. 8 is a block diagram showing an example configuration of a logic chip.

FIG. 9 is a block diagram showing an example configuration of a pixel array unit and a vertical control unit.

FIG. 10 is a diagram showing an example configuration of a signal processing unit.

FIG. 11 is a schematic block diagram of an optical device.

FIG. 12 is a schematic diagram explaining a photon counting strategy.

FIG. 13 is a schematic illustration of the assignment of imaging parameter values in an optical device.

FIG. 14 is a schematic illustration of a prediction of imaging parameter value assignment.

FIG. 15 is a further schematic illustration of a prediction of imaging parameter value assignment.

FIG. 16 is a schematic process flow of a method for training an artificial intelligence model.

FIG. 17 is a schematic block diagram of an artificial intelligence model.

FIG. 18 is a schematic illustration of different reconstruction modes for generating final images.

FIG. 19 is a schematic block diagram of an optical device on a chip.

FIG. 20 is a schematic process flow of a method for operating an optical device.

FIG. 21 is a schematic diagram illustrating an imaging apparatus including an optical device.

FIG. 22 is a block diagram illustrating a configuration example of a distance measurement apparatus as an electronic apparatus including an optical device.

FIG. 23 is a block diagram illustrating a schematic configuration example of a pixel in a pixel array unit of an optical device of a distance measurement apparatus.

FIG. 24 is a diagram schematically illustrating distance measurement by a direct time of flight (ToF) method.

FIG. 25 is a diagram illustrating an example of a histogram based on light reception time generated in the distance measurement.

FIG. 26 is a block diagram illustrating an example of a schematic configuration of an in-vivo information acquisition system.

FIG. 27 is a diagram illustrating an example of a schematic configuration of an endoscopic surgery system.

FIG. 28 is a block diagram illustrating an example of a functional configuration of a camera head and a CCU.

FIG. 29 is a block diagram illustrating an example of schematic configuration of a vehicle control system.

FIG. 30 is a diagram of assistance in explaining an example of installation positions of an outside-vehicle information detecting section and an imaging section.

### DETAILED DESCRIPTION

In order to facilitate understanding of the present disclosure general properties of single photon avalanche diodes, SPADs, will be described.

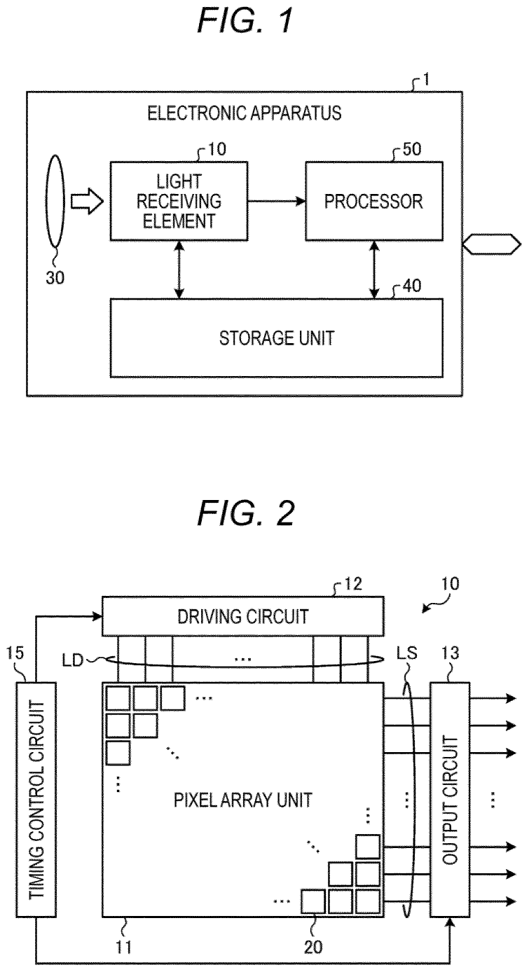

FIG. 1 is a block diagram illustrating a schematic configuration example of an electronic apparatus to which an optical device according to an existing technology is applied. As illustrated in FIG. 1, the electronic apparatus 1 includes, for example, an imaging lens 30, an optical device 10, a storage unit 40, and a processor 50.

The imaging lens 30 is an example of an optical system that condenses incident light and forms an image thereof on a light receiving surface of the optical device 10. The light receiving surface may be a surface on which pixels are arranged in a matrix in the optical device 10. The optical device 10 photoelectrically converts the incident light to generate image data. Further, the optical device 10 executes predetermined signal processing such as noise removal and white balance adjustment on the generated image data.

The storage unit 40 includes, for example, a flash memory, a dynamic random access memory (DRAM), a static random access memory (SRAM), or the like, and records image data or the like input from the optical device 10.

The processor 50 is configured using, for example, a central processing unit (CPU) or the like, and may include an application processor that executes an operating system, various application software, and the like, a graphics processing unit (GPU), a baseband processor, and the like. The processor 50 executes various processes as necessary on image data input from the optical device 10, image data read from the storage unit 40, or the like, executes display to the user, and transmits the image data to the outside via a predetermined network.

FIG. 2 is a block diagram illustrating a schematic configuration example of the above-described optical device 10. As illustrated, the optical device 10 includes a pixel array unit 11, a timing control circuit 15, a driving circuit 12, and an output circuit 13.

The pixel array unit 11 includes a plurality of pixels 20 arranged in a matrix. To the plurality of pixels 20, a pixel driving line LD (vertical direction in the drawing) is connected for every column, and an output signal line LS (horizontal direction in the drawing) is connected for every row. One end of the pixel driving line LD is connected to an output end corresponding to each column of the driving circuit 12, and one end of the output signal line LS is connected to an input end corresponding to each row of the output circuit 13.

The driving circuit 12 includes a shift register, an address decoder, and the like, and drives the pixels 20 of the pixel array unit 11 all at once or in units of columns or the like. The driving circuit 12 applies a selection control voltage to the pixel driving line LD corresponding to the column to be read, to thereby select the pixels 20 to be used for detecting incidence of photons in units of columns. A signal (referred to as a detection signal) output from each pixel 20 of the column selectively scanned by the driving circuit 12 is input to the output circuit 13 through each of the output signal lines LS. The output circuit 13 outputs the detection signal input from each pixel 20 to the storage unit 40 or the processor 50 as a pixel signal.

The timing control circuit 15 includes a timing generator or the like that generates various timing signals, and controls the driving circuit 12 and the output circuit 13 on the basis of the various timing signals generated by the timing generator.

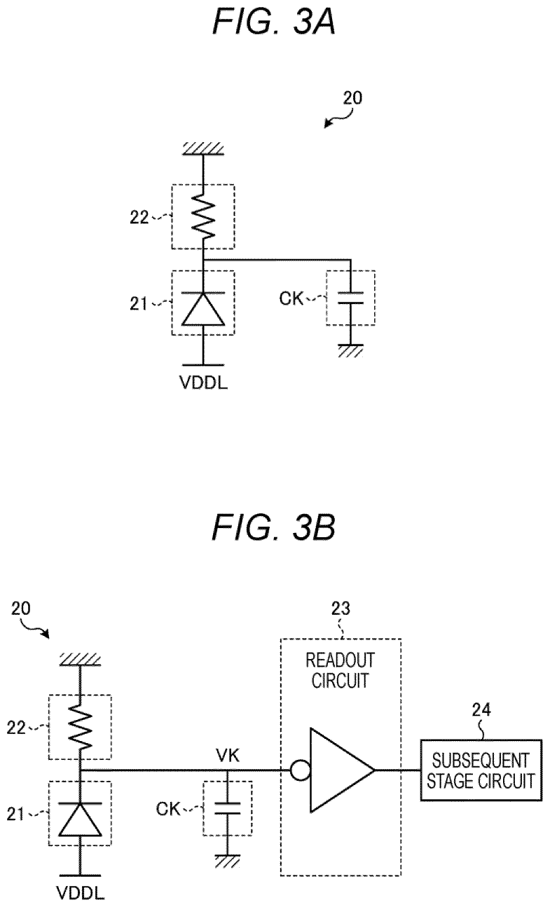

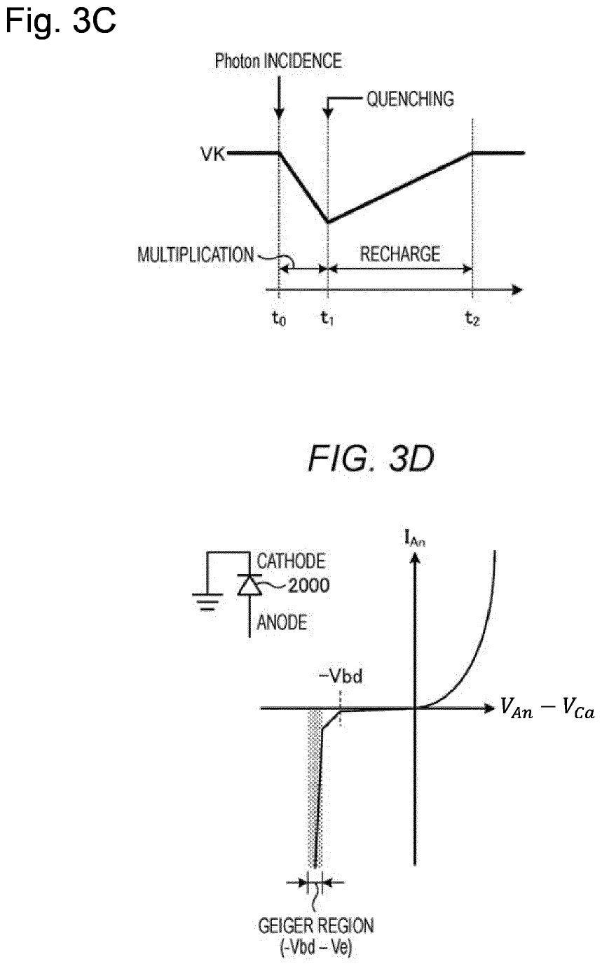

FIG. 3A is a block diagram illustrating an example of a schematic configuration of the pixel 20 of the pixel array unit 11. As illustrated, the pixel 20 includes a photodiode 21 and a quench resistor 22. In this pixel 20, the photodiode 21 is a single photon avalanche diode (hereinafter referred to as a SPAD 21). In the SPAD 21, even if one photon is incident, a large current is generated by avalanche multiplication, and this current is output as an electric signal. The operation of the SPAD 21 will be described later.

In the illustrated example, the anode of the SPAD 21 is connected to a predetermined power supply, and the cathode of the SPAD 21 is connected to one end of the quench resistor 22. The other end of the quench resistor 22 is grounded. Thus, a reverse bias voltage VDDL can be applied across the SPAD 21 as described later. Further, a cathode parasitic capacitance CK as a parasitic capacitance is generated on the cathode side of the SPAD 21. The cathode parasitic capacitance CK corresponds to a combined capacitance of the capacitance of the SPAD 21, a capacitance generated between the quench resistor 22 and a surrounding insulating layer, a capacitance generated by a wiring connecting the SPAD 21 and the quench resistor 22, a capacitance of an element such as an inverter included in a readout circuit 23, and the like.

Referring to FIG. 3B, the readout circuit 23 is connected to a connection point between the SPAD 21 and the quench resistor 22 in the pixel 20. The readout circuit 23 can include, for example, an inverter circuit, and reads a change in potential (that is, cathode potential) at a connection point between the SPAD 21 and the quench resistor 22 as described later.

Further, in the pixel 20, a circuit 24 in a subsequent stage may be connected to an output end of the readout circuit 23. The circuit 24 in the subsequent stage can include, for example, a digital counter circuit, with which the pixel 20 can function as a photon counter element. In this case, image data can be generated on the basis of an output signal corresponding to the number of photons detected in each pixel 20. That is, the optical device 10 can function as an imaging sensor.

Further, the circuit 24 in the subsequent stage can include a time-to-digital converter (TDC) instead of the digital counter circuit. The TDC circuit can generate a digital signal indicating a time difference between a predetermined reference signal having a predetermined reference frequency and a detection signal based on the reference signal. In a case where the circuit 24 in the subsequent stage includes the TDC circuit, the optical device 10 can function as a distance measurement element by time of flight (ToF) method, for example.

Next, the operation of the SPAD 21 will be described with reference to FIGS. 3C and 3D. FIG. 3C is a graph schematically illustrating a change in a cathode potential VK of the SPAD 21 when one photon is incident on the SPAD 21. FIG. 3D is a graph schematically illustrating voltage-current characteristics of the SPAD 21. In FIG. 3D, the horizontal axis indicates a voltage applied across the anode and the cathode of the SPAD 21. This applied voltage is represented by V_{An}−V_{Ca} where an anode potential of the SPAD 21 is V_{An} and the cathode potential is V_{Ca}. Further, in FIG. 3D, the vertical axis indicates the current I_{An} flowing through the SPAD 21 in a forward direction (direction from the anode to the cathode). and its current value increases as the applied voltage increases, as illustrated in FIG. 3D. On the other hand, in a case where the reverse bias voltage is applied to the SPAD 21, when the voltage is low, the current I_{An} does not flow due to rectifying action of the SPAD 21. However, when the reverse bias voltage becomes equal to or lower than a breakdown voltage −Vbd, the avalanche multiplication occurs, and the large current I_{An} flows in the reverse direction. Here, a region between the breakdown voltage (−Vbd) and a voltage (−Vbd−Ve) that is further lower than the breakdown voltage by a voltage Ve (also referred to as an excess voltage Ve) is called a Geiger region. In the Geiger region, gain due to avalanche multiplication is theoretically infinite. By applying the reverse bias voltage of, for example, several 10 V to both ends of the SPAD 21, the SPAD 21 can operate in the Geiger region.

Here, in a case where a predetermined voltage corresponding to the Geiger region is applied across the anode of the SPAD 21 and a ground terminal of the quench resistor 22 from the predetermined power supply, when a photon (may be one photon) is incident on the SPAD 21 (at t₀ in FIG. 3C), an electron-hole pair is generated by the photon, this electron-hole pair is accelerated by a high electric field due to the reverse bias voltage, and such electron-hole pairs are generated one after another. That is, the avalanche multiplication occurs. Thus, a large current flows in the opposite direction.

This current also flows through the quench resistor 22, and thus a voltage drop by the quench resistor 22 occurs. Thus, the applied voltage that is applied to the SPAD 21 decreases. Here, when (the absolute value of) the voltage applied across the cathode and the anode of the SPAD 21 becomes lower than the breakdown voltage (absolute value |Vbd|), the avalanche amplification stops (time t₁). A phenomenon in which the avalanche multiplication is stopped is called quenching.

Thereafter, the current is supplied to the SPAD 21 through the quench resistor 22, and the SPAD 21 is charged. This charge is called recharge. The recharge is performed over a certain period (time t₁ to t₂) with a time constant determined by the cathode parasitic capacitance CK (FIGS. 3A and 3B). When the recharge is completed (time t₂), the voltage applied to the SPAD 21 returns to the voltage corresponding to the Geiger region, and the SPAD 21 can operate in this region again. As described above, in a case where the photon is incident on the SPAD 21, the cathode potential VK of the SPAD 21 changes in a pulse shape as illustrated in FIG. 3C. Such a change is read by the readout circuit 23, and consequently, the photon is detected. Note that since the SPAD 21 cannot detect the photon during the recharge period, this period is referred to as a dead time.

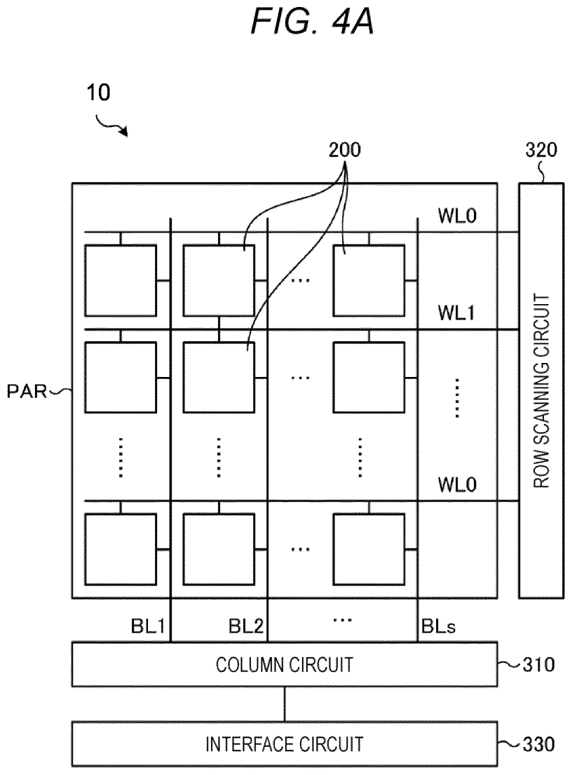

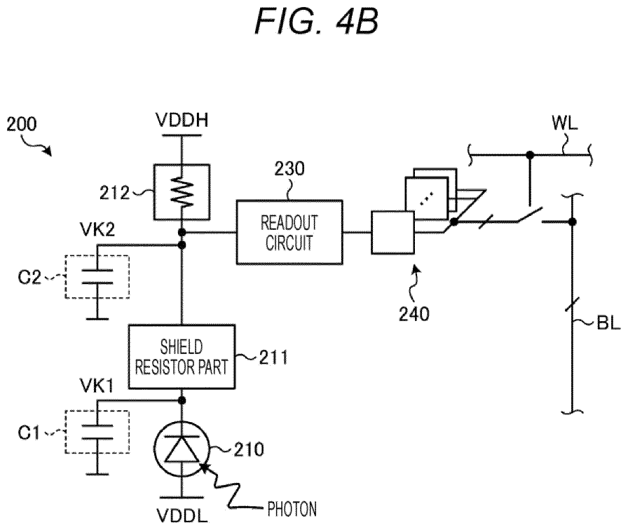

Next, a possible configuration example of the optical device will be described. FIG. 4A is a block diagram illustrating a schematic configuration example of the optical device 10. As illustrated, the optical device 10 includes a pixel array unit PAR, a column circuit 310, a row scanning circuit 320, and an interface circuit 330.

The pixel array unit PAR includes a plurality of pixels (light receiving elements) 200 arranged in a matrix. Bit lines BL₀, BL₁, . . . , and BL_{S} (also referred to as the bit line BL in a case where it is not particularly necessary to distinguish) are connected to the plurality of pixels 200 for every column, and word lines WL₀, WL₁, . . . , and WL_{N} (also referred to as a word line WL in a case where it is not particularly necessary to distinguish) are connected to the plurality of pixels for every row. One end of the bit line BL is connected to an output end corresponding to each column of the column circuit 310, and one end of the word line WL is connected to an input end corresponding to each row of the row scanning circuit 320. Note that for convenience of description, the vertical direction is referred to as a column direction and the horizontal direction is referred to as a row direction in the drawing.

The row scanning circuit 320 drives the pixels 200 of the pixel array unit PAR all at once or in units of columns or the like. The row scanning circuit 320 applies the selection control voltage to the word line WL corresponding to the column to be read out, to thereby select the pixels 200 to be used for detecting incidence of photons in units of columns. A signal (referred to as a detection signal) output from each pixel 200 of the column selectively scanned by the row scanning circuit 320 is input to the column circuit 310 through each of the bit lines BL. The column circuit 310 generates a digital signal by digitally converting the detection signal. The generated digital signal is output to the outside through the interface circuit 330. Note that the column circuit 310 and the row scanning circuit 320 are controlled by a timing signal from a timing control circuit (not illustrated).

FIG. 4B is a block diagram illustrating a schematic configuration example of the pixel 200 in the pixel array unit PAR of the optical device 10. As illustrated, the pixel 200 includes a photodiode 210, a shield resistor part 211, and a quench resistor part 212. The photodiode 210 is a SPAD and will be hereinafter referred to as a SPAD 210. The SPAD 210 multiplies a charge generated by photoelectric conversion in response to incidence of one photon by the avalanche multiplication (also referred to as avalanche amplification) to generate a large current, and outputs the current as an electric signal. However, the photodiode 210 is not limited to the SPAD and may be a silicon photomultiplier tube.

One end of the shield resistor part 211 is connected to a cathode of the SPAD 210, and the other end of the shield resistor part 211 is connected to one end of the quench resistor part 212. That is, in the pixel 200, a series circuit is formed in which the SPAD 210, the shield resistor part 211, and the quench resistor part 212 are connected in series.

The shield resistor part 211 and the quench resistor part 212 can be formed by, for example, high-resistance polysilicon. Further, the shield resistor part 211 and the quench resistor part 212 may be formed as metal resistors. As a material for the metal resistor, what is called cermet-based materials such as TaSiO₂ and NbSiO₂ are exemplified. Here, when a resistance value of the shield resistor part 211 is denoted by Rsh and a resistance value between a cathode and an anode of the SPAD 210 is R_{ON}, a relationship of _{RON}<Rsh is satisfied. That is, the shield resistor part 211 is formed to have a resistance value larger than the resistance value between the cathode and the anode of the SPAD 210.

Further, when a resistance value of the quench resistor part 212 is denoted by Rq, a relationship of Rsh<Rq is satisfied. That is, the shield resistor part 211 and the quench resistor part 212 are formed such that the resistance value Rq of the quench resistor part 212 is larger than the resistance value Rsh of the shield resistor part 211.

Further, as illustrated in FIG. 4B, a parasitic capacitance C1 is generated on the cathode side of the SPAD 210. The parasitic capacitance C1 corresponds to a combined capacitance such as a capacitance of the SPAD 210 and a capacitance generated by a wiring connecting the SPAD 210 and the shield resistor part 211. Moreover, a parasitic capacitance C2 is generated between the shield resistor part 211 and the quench resistor part 212. The parasitic capacitance C2 corresponds to a combined capacitance of a capacitance generated between the shield resistor part 211 and a surrounding insulating layer, a capacitance generated between the quench resistor part 212 and a surrounding insulating layer, a capacitance generated by a wiring connecting the shield resistor part 211 and the quench resistor part 212, a capacitance of an element such as an inverter included in a readout circuit 230, and the like. Note that since many circuit elements exist such as the shield resistor part 211, the quench resistor part 212, and the readout circuit 230 (described later) around the parasitic capacitance C2 as compared with the periphery of the parasitic capacitance C1, the capacitance (value) of the parasitic capacitance C2 tends to be larger than the capacitance (value) of the parasitic capacitance C1.

One end of the readout circuit 230 is connected to a connection point between the shield resistor part 211 and the quench resistor part 212. The readout circuit 230 can include, for example, an inverter circuit. The readout circuit 230 reads a change in potential at the connection point between the shield resistor part 211 and the quench resistor part 212.

Further, in the pixel 200, the digital counter circuit 240 is connected to an output end of the readout circuit 230. The digital counter circuit 240 counts the number of changes in potential at the connection point between the shield resistor part 211 and the quench resistor 22 read by the readout circuit 230, that is, the number of photons incident on the SPAD 210, and outputs an output signal corresponding to the counted number. When a selection signal is input from the row scanning circuit 320 (FIG. 4A) to the pixel 200 through the word line WL, the output signal is output from the digital counter circuit 240 to the column circuit 310 through the bit line BL. By converting the output signal into luminance, the optical device 10 can function as an image pickup element.

Note that the TDC circuit may be connected to the subsequent stage of the readout circuit 230 instead of the digital counter circuit. With this configuration, distance measurement by a direct ToF method can be performed on the basis of the difference between a light emission timing and a light reception timing on the basis of the output from the readout circuit 230.

Further, the optical device 10 can also function as a distance measurement unit that performs distance measurement by an indirect ToF method in which a light receiving unit receives light for each phase according to light emission of a predetermined light source unit and calculates distance information on the basis of a light reception signal for each phase output by the light receiving unit by light reception for each phase.

As illustrated in FIG. 4B, a series circuit including the SPAD 210, the shield resistor part 211, and the quench resistor part 212 is connected to the predetermined power supply, the anode of the SPAD 210 is maintained at the potential VDDL, and the other end of the quench resistor part 212 (the end opposite to the one end connected to the shield resistor part 211) is maintained at a potential VDDH. That is, a voltage corresponding to the potential VDDH—potential VDDL is applied to the series circuit including the SPAD 210, the shield resistor part 211, and the quench resistor part 212. Here, since the potential VDDH is higher than the potential VDDL, the reverse bias voltage is applied to the SPAD 210. During the operation of the pixel 200, this applied voltage is set to the predetermined voltage corresponding to the Geiger region described above.

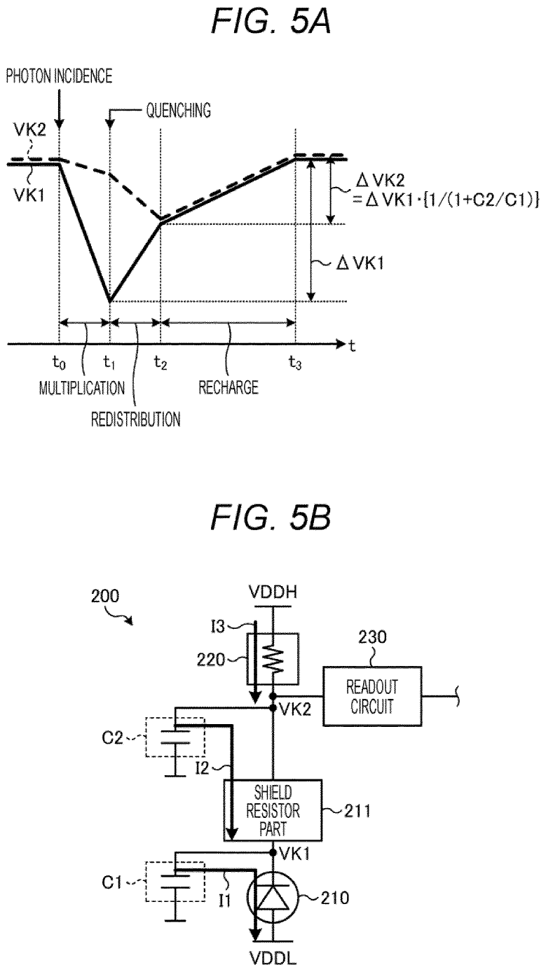

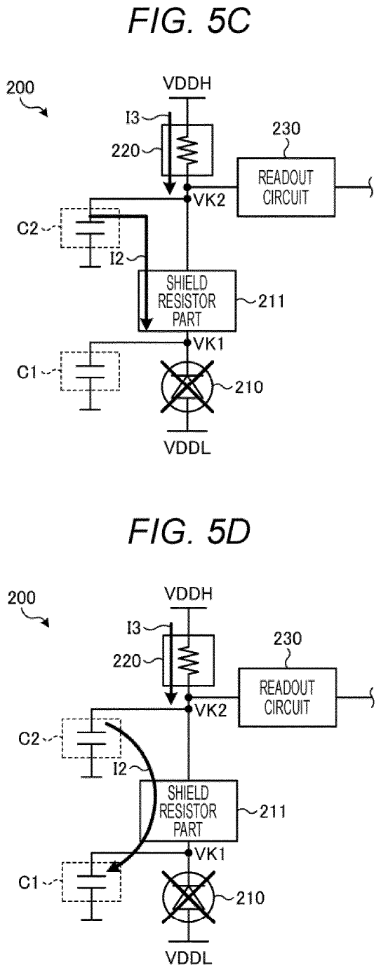

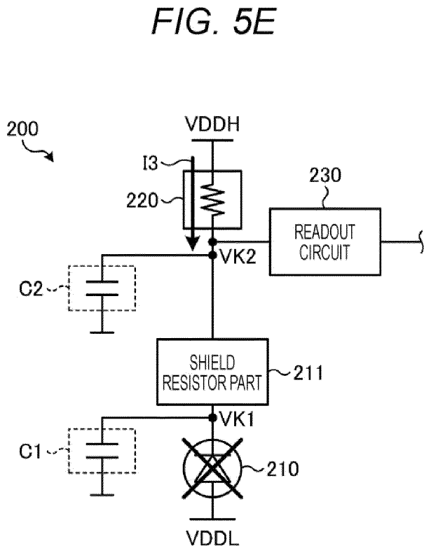

Next, the operation of the pixel 200 will be described with reference to FIGS. 5A to 5E. In FIGS. 5B to 5E, the pixel 200 is schematically illustrated similarly to FIG. 4B, but the digital counter circuit 240 (or TDC circuit), the word line WL, the bit line BL, and the like are omitted.

First, the predetermined voltage is applied to the series circuit by the SPAD 210, the shield resistor part 211, and the quench resistor part 212 by the predetermined power supply. That is, the (reverse bias) voltage corresponding to the Geiger region is applied to the SPAD 210. When photons are incident on the SPAD 210 in this state (time t₀ in FIG. 5A), the avalanche multiplication occurs, and the large current flows from the cathode to the anode in the SPAD 210. Here, in FIG. 5B, as a current I2 flowing out from the parasitic capacitance C2 is schematically represented by a thin arrow and a current I1 flowing out from the parasitic capacitance C1 is schematically represented by a thick line, the large current flowing from the cathode to the anode of the SPAD 210 is mainly supplied from the parasitic capacitance C1. This is because the shield resistor part 211 having the resistance value Rsh larger than the resistance value R_{ON} between the cathode and the anode of the SPAD 210 is provided between the parasitic capacitance C2 and the SPAD 210. In other words, while charges accumulated in the parasitic capacitance C1 easily move to the SPAD 210, charges accumulated in the parasitic capacitance C2 are hindered by the shield resistor part 211 and hardly moves to the SPAD 210, and thus the current is mainly supplied from the parasitic capacitance C1 to the SPAD 210 during the avalanche multiplication.

During the avalanche multiplication, as illustrated in the period t₀ to t₁ in FIG. 5A, a cathode potential VK1 of the SPAD 210 decreases due to the large current generated by the avalanche multiplication. When the voltage applied across the SPAD 210 becomes lower than the breakdown voltage as the cathode potential VK1 decreases, the quenching occurs (time t₁ in FIG. 4C). Further, at this time, the charges accumulated in the parasitic capacitance C1 have been discharged, and the supply of the current Il from the parasitic capacitance C1 to the SPAD 210 is also stopped as illustrated in FIG. 5C.

Note that, as illustrated in FIG. 5A, in the avalanche multiplication period (t₀ to t₁), a potential VK2 between the shield resistor part 211 and the quench resistor part 212 does not drop as much as the potential VK1. This is because the current hardly flows from the parasitic capacitance C2 as described above.

The quenching occurs and charge redistribution starts between the parasitic capacitance C1 and the parasitic capacitance C2 (time t₁ in FIG. 5A). That is, as illustrated in FIG. 5D, the charges remaining in the parasitic capacitance C2 move to the parasitic capacitance C1 through the shield resistor part 211. Here, since the resistance value Rq of the quench resistor part 212 is larger than the resistance value Rsh of the shield resistor part 211, a current I3 flowing through the quench resistor part 212 only slightly contributes to the redistribution of charges. Thus, the charge redistribution is mainly performed between the parasitic capacitance C2 and the parasitic capacitance C1. When the voltage between the parasitic capacitance C1 and the voltage between the parasitic capacitance C2 become equal (when the potential VK1 and the potential VK2 become equal), the redistribution ends (time t₂).

When the redistribution ends, the recharge is started. That is, since the current I2 from the parasitic capacitance C2 does not flow, as illustrated in FIG. 5E, the recharge of the SPAD 210 proceeds by the current I3 flowing through the quench resistor part 212. Here, there is no charge loss in redistribution of charges between the parasitic capacitance C2 and the parasitic capacitance C1, and thus the charge amount necessary for recharge is equal to C1ΔVK1 consumed by the avalanche multiplication. That is, a charge amount equal to C1ΔVK1 is supplied to the SPAD 210 by the current I3. When the recharge ends (time t₃), the SPAD 210 becomes capable of detecting a photon again.

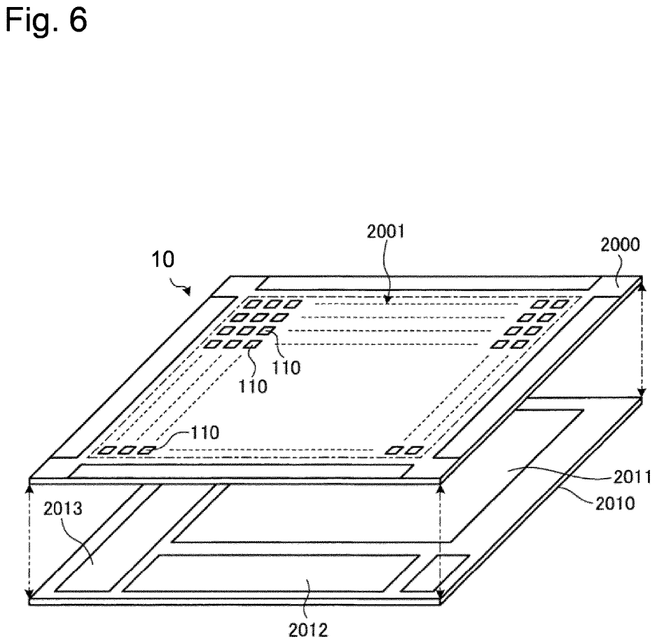

FIG. 6 is a schematic diagram showing another example of an optical device 10. In FIG. 6, the optical device 10 is constructed by stacking a light-receiving chip 2000 and a logic chip 2010 which are respectively made of semiconductor chips. It should be noted that FIG. 6 shows the light-receiving chip 2000 and the logic chip 2010 being separated from each other for the sake of description.

The light-receiving chip 2000 includes a pixel array unit 2001 made by, for example, arranging a plurality of photoelectric conversion elements 110 included on a one-to-one basis in a plurality of pixels in a two-dimensional grid pattern. The logic chip 2010 is provided with a logic array unit 2011 including a signal processing unit that processes a signal acquired by the photoelectric conversion element 110. Each circuit included in the light-receiving chip 2000 and each circuit included in the logic chip 2010 are electrically connected by a CCC (Copper-Copper Connection) or the like. The logic chip 2010 may be further provided with, in close proximity to the logic array unit 2011, a storage unit 2012 that stores a signal acquired by the photoelectric conversion element 110 and an element control unit 2013 that controls an operation as the optical device 10.

In this case, a CCC refers to a connection mode in which the light-receiving chip 2000 and the logic chip 2010 are electrically connected to each other by directly joining a partial wiring included in a wiring layer of the light-receiving chip 2000 and a partial wiring included in a wiring layer of the logic chip 2010 with each other. The wiring in this case can be formed of a conductive material such as metal of which an example is copper.

The connection mode between the light-receiving chip 2000 and the logic chip 2010 is not limited to a CCC. For example, the light-receiving chip 2000 and the logic chip 2010 can also be connected to each other by a bump connection or a through electrode.

Objects of the electrical connection between the light-receiving chip 2000 and the logic chip 2010 include transmission of a pixel signal generated by the light-receiving chip 2000 to the logic chip 2010 and supplying externally-applied power into the light-receiving chip 2000 and the logic chip 2010.

For example, externally-applied power is supplied to the wiring layer of the light-receiving chip 2000 via a bonding pad (an extractor electrode) that is provided outside of the pixel array unit 2001 in the light-receiving chip 2000. The wiring layer of the light-receiving chip 2000 and the wiring layer of the logic chip 2010 are directly connected to each other by a connecting portion such as the CCC described above and power is supplied to the logic chip 2010 from the light-receiving chip 2000.

While a connecting portion that provides electrical connection between the light-receiving chip 2000 and the logic chip 2010 is described above as being provided with respect to the pixel 10 on a one-to-one basis, a configuration of the connecting portion is not limited to this example. For example, a configuration in which one connecting portion is provided with respect to a plurality of pixels or a configuration in which a plurality of connecting portions are provided with respect to one pixel may be adopted.

In addition to controlling the logic array unit 2011, the element control unit 2013 may be arranged in a vicinity of, for example, the photoelectric conversion element 110 for other driving or controlling purposes. In addition to the arrangement shown in FIG. 6, the element control unit 2013 may be provided so as to have an arbitrary function in an arbitrary region of the light-receiving chip 2000 and the logic chip 2010.

While only the photoelectric conversion element 110 among the respective elements included in the pixel is described above as being arranged on the light-receiving chip 2000, the configuration of the light-receiving chip 2000 is not limited thereto. Specifically, a signal processing circuit that converts an electric charge having been read from the photoelectric conversion element 110 into an electric signal may be further arranged on the light-receiving chip 2000. Furthermore, a circuit that subjects an electric signal output from the signal processing circuit to another type of signal processing may be further arranged on the light-receiving chip 2000.

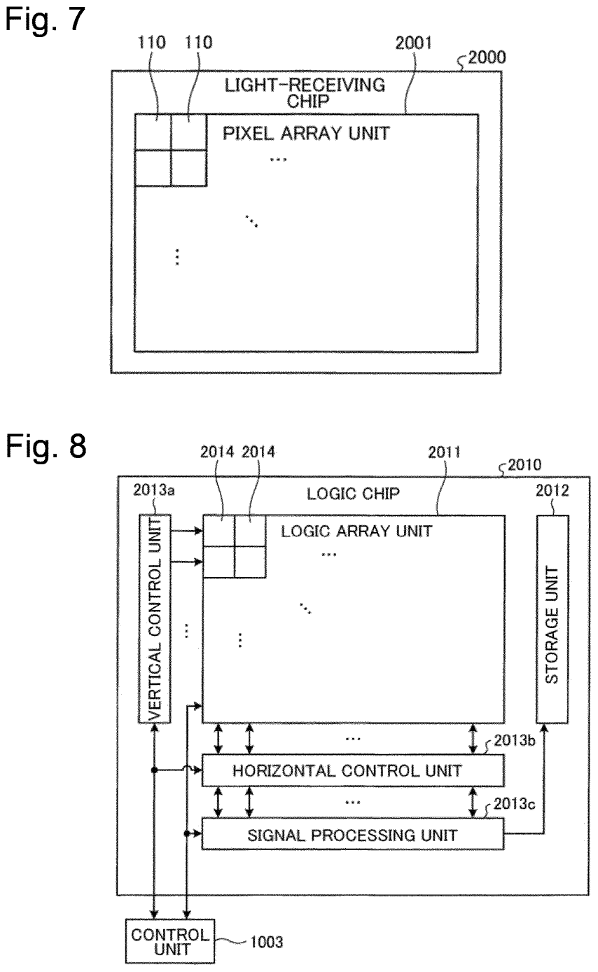

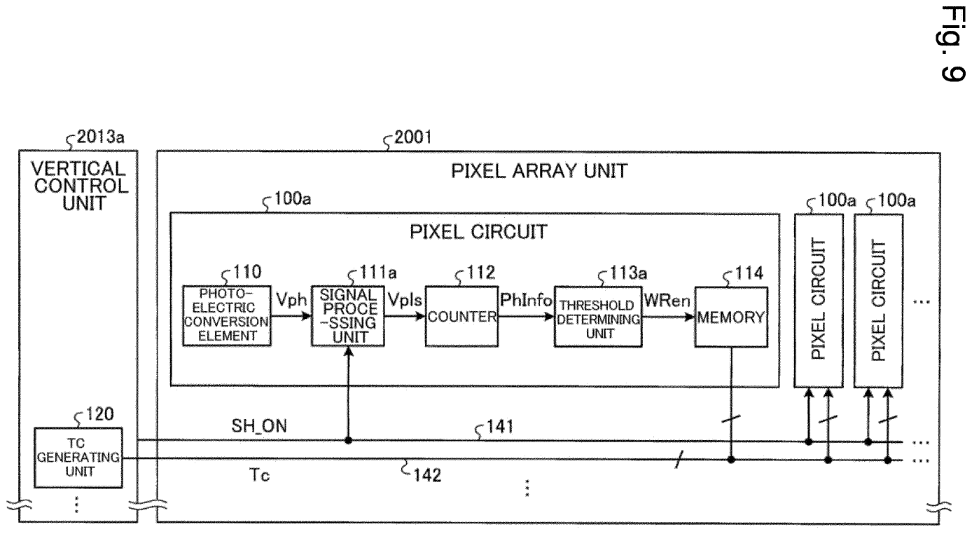

Next, more specific configuration examples of the light-receiving chip 2000 and the logic chip 2010 will be described using FIGS. 7 and 8. FIG. 7 is a plan view showing an example configuration of the light-receiving chip 2000. The light-receiving chip 2000 is provided with the pixel array unit 2001, and the pixel array unit 2001 is provided with a plurality of photoelectric conversion elements 110 arranged in a two-dimensional grid pattern.

FIG. 8 is a block diagram showing an example configuration of the logic chip 2010. In the example shown in FIG. 8, a vertical control unit 2013a, the logic array unit 2011, a horizontal control unit 2013b, a signal processing unit 2013c, and the storage unit 2012 are arranged on the logic chip 2010. Among these units, the vertical control unit 2013a, the horizontal control unit 2013b, and the signal processing unit 2013c may be configured so as to be included in the element control unit 2013. in addition, a logic circuit 2014 is arranged for each photoelectric conversion element 110 in the logic array unit 2011. Each of the logic circuits 2014 is connected via a signal line to a corresponding photoelectric conversion element 110. A circuit made up of the photoelectric conversion element 110 and the logic circuit 2014 that corresponds to the photoelectric conversion element 110 functions as a pixel circuit that generates a pixel signal by one pixel.

For example, a vertical synchronization signal and a horizontal synchronization signal may respectively be supplied to the vertical control unit 2013a and the horizontal control unit 2013b. In addition, an exposure control signal may be respectively supplied to the logic array unit 2011 and the signal processing unit 2013c.

In this case, a predetermined direction of the two-dimensional grid (for example, a lateral direction in FIGS. 7 and 8) is assumed to be a row direction and a direction that is perpendicular to a row is assumed to be a column direction. In other words, the pixel circuit (the photoelectric conversion element 110 and the logic circuit 2014) is arranged so as to be aligned in the row direction and the column direction with respect to the pixel array unit 2001 and the logic array unit 2011. Hereinafter, unless otherwise noted, a group of pixel circuits in the row direction will be referred to as a “row” and a group of pixel circuits in the column direction will be referred to as a “column”.

The vertical control unit 2013a sequentially selects rows in synchronization with vertical synchronization signals. The logic circuit 2014 is capable of outputting a time code Tc stored in a memory. The time code Tc output from each logic circuit 2014 is supplied to the signal processing unit 2013c. The horizontal control unit 2013b sequentially selects columns in synchronization with horizontal synchronization signals and causes pixel signals to be output.

Furthermore, information indicating the exposure period Tsh (an exposure start timing, an exposure time, or the like) may be input to the signal processing unit 2013c. Based on the respective time codes Tc supplied from the respective logic circuits 2014, the signal processing unit 2013c calculates the predicted count value Npre according to, for example, the equation (1) described earlier. The signal processing unit 2013c outputs each calculated predicted count value Npre. Each predicted count value Npre output from the signal processing unit 2013c is supplied to and stored by the storage unit 2012.

FIG. 9 is a block diagram showing an example configuration of the pixel array unit 2001 and the vertical control unit 2013a. In addition, FIG. 9 shows a more specific configuration of a pixel circuit with respect to the pixel array unit 2001.

As exemplified in FIG. 9, the pixel array unit 2001 includes a plurality of pixel circuits 100a. It should be noted that FIG. 9 extracts and shows the respective pixel circuits 100a included in one row among the respective pixel circuits 100a that are arranged in a two-dimensional grid pattern in the pixel array unit 2001.

In FIG. 9, the pixel circuit 100a includes the photoelectric conversion element 110, a signal processing unit 111a, a counter 112, a threshold determining unit 113a, and a memory 114.

The photoelectric conversion element 110 outputs a signal Vph in accordance with an incidence of a photon. In a case of the configuration shown in FIG. 6 described above, for example, the signal Vph is transmitted from the light-receiving chip 2000 to the logic chip 2010 via a coupling portion constituted by a CCC and supplied to the signal processing unit 111a that is arranged on the logic chip 2010. The signal processing unit 111a shapes the signal Vph output from the photoelectric conversion element 110 and outputs the shaped signal Vph as a pulse Vpls in accordance with an incidence of a photon. An output timing of the pulse Vpls is controlled in accordance with a signal SH_ON that is supplied from a TC generating unit 120 to be described later. The counter 112 counts the number of pulses Vpls that are output from the signal processing unit 111a and outputs a count result as photon information PhInfo.

The threshold determining unit 113a makes a determination based on the threshold Nth with respect to the photon information PhInfo having been output from the counter 112. Based on the photon information PhInfo, when the threshold determining unit 113a determines that the photon number incident to the photoelectric conversion element 110 exceeds the threshold Nth, the threshold determining unit 113a outputs a write signal WRen(W).

The memory 114 stores the time code Tc that is supplied from the TC generating unit 120 (to be described later) via a signal line 142 in accordance with the write signal WRen. The memory 114 includes a memory control unit that controls writing of data to the memory 114 itself and reading of data from the memory 114.

On the other hand, in FIG. 9, the vertical control unit 2013a includes a TC (time code) generating unit 120 for each row.

The TC generating unit 120 generates an update cycle that changes as the exposure period Tsh elapses and generates the time code Tc based on the update cycle. For example, a reference timing signal may be supplied to the TC generating unit 120. Based on the reference timing signal, the TC generating unit 120 generates the time code Tc at a predetermined update cycle. In the example shown in FIG. 8, the time code Tc generated by the TC generating unit 120 is input to the respective pixel circuits 100a via the signal line 142 and respectively supplied to and stored in the memory 114 included in each pixel circuit 100a.

Each time code Tc stored in the memory 114 included in each pixel circuit 100a is read from the memory 114 via the signal line 142.

For example, a start timing of the exposure period Tsh may be indicated to the TC generating unit 120 and supplies the TC generating unit 120 with information indicating a length of the exposure period Tsh.

In addition, the TC generating unit 120 generates a signal SH_ON that indicates a timing at which the signal processing unit 11 la outputs the pulse Vpls. For example, the TC generating unit 120 generates the signal SH_ON based on a predetermined clock signal. In the example shown in FIG. 9, the signal SH_ON generated by the TC generating unit 120 is input to the respective pixel circuits 100a via the signal line 141 and supplied to the signal processing unit 111a.

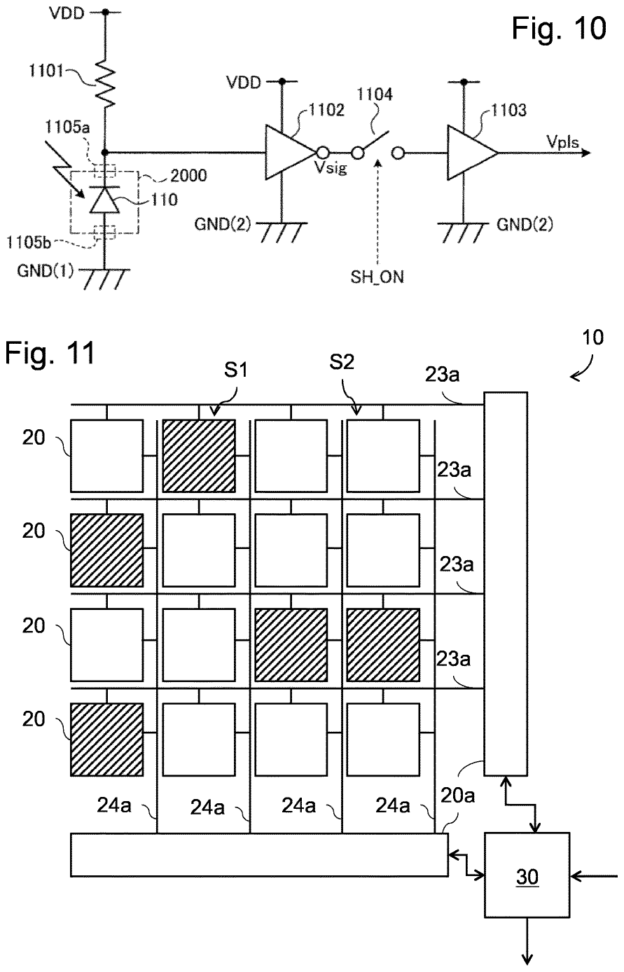

FIG. 10 is a diagram showing an example configuration of the signal processing unit 111a. In FIG. 10, the signal processing unit 111a includes a resistor 1101, an inverter 1102, an amplifier 1103, and a switch 1104.

In FIG. 10, in the photoelectric conversion element 110 that is, for example, a SPAD, a cathode is connected to a terminal of a power supply potential VDD via the resistor 1101, and an anode is connected to a terminal of a potential GND(1) with a lower potential than the power supply potential VDD. The terminal of a potential GND(1) is, for example, a grounding terminal. Accordingly, a reverse bias is applied to the photoelectric conversion element 110. In addition, a photocurrent flows in a direction from the cathode toward an anode of the photoelectric conversion element 110.

It should be noted that the photoelectric conversion element 110 is not limited to a SPAD. An avalanche photodiode (APD) or an ordinary photodiode can also be applied as the photoelectric conversion element 110.

One end of the resistor 1101 is connected to the power supply potential VDD and another end is connected to the cathode of the photoelectric conversion element 110. A photocurrent flows through the resistor 1101 every time an incidence of a photon is detected by the photoelectric conversion element 110 and a cathode potential of the photoelectric conversion element 110 drops to a value of an initial state that is lower than the power supply potential VDD (a quenching operation).

A signal extracted from a connection point between the resistor 1101 and the cathode of the photoelectric conversion element 110 is input to the inverter 1102. The inverter 1102 inverts the input signal of the cathode potential of the photoelectric conversion element 110 and supplies an inverted output signal Vsig to the amplifier 1103 via the switch 1104. The amplifier 1103 shapes the inverted output signal Vsig and outputs the shaped inverted output signal Vsig as a pulse Vpls. In addition, a ground-side potential GND(2) to which the inverter 1102 and the amplifier 1103 are connected differs from the ground-side potential GND(1) to which the anode of the photoelectric conversion element 110 is connected.

In FIG. 10, the photoelectric conversion element 110 is formed on the light-receiving chip 2000. In addition, the resistor 1101, the inverter 1102, the amplifier 1103, and the switch 1104 are formed on the logic chip 2010. The cathode of the photoelectric conversion element 110 is connected to, via a coupling portion 1105a constituted by a CCC or the like, a connection point where the resistor 1101 and an input terminal of the inverter 1102 are connected to each other. In addition, the anode of the photoelectric conversion element 110 is connected to, via a coupling portion 1105b constituted by a CCC or the like, a supply line for supplying the ground-side potential GND(1) which is arranged on the logic chip 2010.

FIG. 11 is a schematic block diagram of an optical device 10 that can be used to capture a scene while concurrently using different values for specific imaging parameters.

The optical device 10 comprises a plurality of pixels 20, which are preferably, but not necessarily, arranged in a two-dimensional array. Each pixel 20 is configured to receive light and perform photoelectric conversion to generate an electrical signal via a single photon avalanche diode, SPAD, as e.g. described above. The pixels 20 are connected with circuitry 20a that is configured to generate image data from the electrical signals based on imaging parameters that are adjustable for each pixel 20.

The circuitry 20a may be configured to count the number of photons detected by each SPAD in each of the pixels 20 and to generate as image data brightness data that indicate the brightness of the scene observed by the respective pixel 20. The adjustable imaging parameter for such an EVS may for example be photon detection efficiency of the SPAD, an exposure time of the SPAD, a dead time of the SPAD, and a photon counting strategy that defines a periodic change of exposure times of the SPAD, or the like. Each of these imaging parameters affects the rate of and/or the sensitivity for event detection, and thus the final imaging result.

For example, the photon detection efficiency of each SPAD in each pixel 20 can be tuned by changing the reset voltage of the respective pixel 20. This will change the sensitivity of the SPAD, and hance the number of photons detected by the pixel 20. Changing the photon detection efficiency can therefore be used to reduce the data amount. In particular, the photon detection efficiency can be low for the observation of bright scenes, but should be high, if weakly illuminated scenes are observed.

The exposure time of the SPAD is the time that can be used to detect a photon. The exposure time can be varied through multiple clocks per row and/or column. Here, the clocks may be generated from a master clock and a clock divider. Also the exposure time can be used to reduce the data amount obtained for brightly illuminated scenes (short exposure time) while ensuring that weakly illuminated scenes or spots in a scene are captured with a long exposure time.

The dead time of the SPAD is the time during which the pixel is kept inactive, e.g. by keeping reset active. Increasing the dead time will of course reduce the amount of gathered data and could hence be used to deal with extremely bright parts of a scene.

A photon counting strategy is a series of consecutive exposure periods, i.e. photon counting periods, that add up to one photon counting frame. This could be used to cope with different illumination conditions. Using different exposure times to add up pixel counts differs from one long exposure time since the photon count is non-linear with brightness. Thus, counting photons coming from a bright part of the scene in several time periods may give different counting results than counting during only a single period.

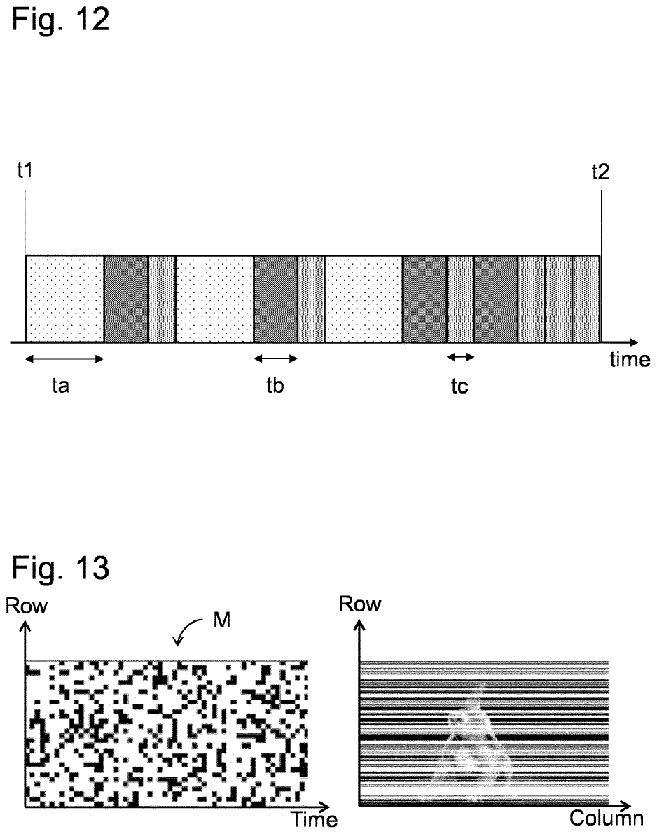

An example of a photon counting strategy is given in FIG. 12. FIG. 12 shows the start time t1 and the end time t2 of a photon counting frame. Within the photon counting frame three different exposure time ta, tb, and tc are used. Here, the exposure with exposure time ta is repeated three times, the exposure with exposure time tb is repeated four times and the exposure with exposure time tc is repeated six times. Thus, in a photon counting strategy the lengths of the exposure times, the number of different exposure times and the number each exposure is repeated can be changed. Changing these parameters will lead to different photon counts even if the same scene is observed. Thus, data rates can also be reduced by selecting a particular photon counting strategy that is optimized for the observed scene.

Of course, it is to be understood that these are mere examples and that also other imaging parameters could be adjustable via the circuitry 20a. In fact, any parameter can be used that has a direct or indirect influence on the outcome of the imaging.

The optical device 10 further comprises a control unit 30 that is configured to divide for each of a series of specific time periods the plurality of pixels 20 into at least a first subset S1 of pixels 20 and a second subset S2 of pixels, and to set for the specific time period to the pixels 20 of each subset S1, S2 a different parameter value of at least one of the imaging parameters. In particular, the control unit 30 dictates the circuitry 20a for every pixel 20 which value is to be set for which imaging parameter. To this end, the control unit 30 may be any kind of processing unit, circuitry, hardware, software or a mixture thereof that is capable to carry out the functions of the control unit 30 discussed herein.

In the example shown in FIG. 11 the control unit 30 controls the circuitry 20a to set one imaging parameter, like e.g. the exposure time of the SPAD, in a first subset S1 of pixels 20 (hatched in FIG. 11) to a first value, while the one imaging parameter is set to a different, second value in a second subset S2 of pixels 20 (blank in FIG. 11). In principle, it is also possible to set different parameter values to each pixel 20 to adjust the values of more than one imaging parameter at the same time, and to use more than two pixel subsets S1, S2. However, for the ease of description in the following it will often be assumed that the pixels 20 are divided into two subsets S1, S2 in which all pixels 20 have a first parameter value and a second parameter value, respectively, of one of the available imaging parameters.

As schematically illustrated in FIG. 11 the circuitry 20a may include row setting lines 23a and column setting lines 24a. Each pixel 20 is connected to a different pair of row setting line 23a and column setting line 24a, which allows generating of different image parameter adjusting signals for each pixel by combining adjusting signals fed into the respective row setting lines 23a and column setting lines 24a. For example, bias voltages and/or currents used in the pixels 20 can be adjusted by applying according voltages/currents to the row setting lines 23a and the column setting lines 24a and by using bias generators as known to a skilled person.

Thus, in principle, parameter values can be freely adjusted across the pixels 20. This allows the control unit 30 to set specific parameter values to each of the pixels during specific time periods and to change the parameter values at the end of each time period. The specific time periods may depend on image capturing parameters like frame rates or the like. The specific time periods may also depend on a change of the type of captured scene or a similar trigger that brings the control unit 30 to a reassignment of parameter values. The specific time periods may also have a predetermined, fixed length, which leads to a periodic update of the assigned imaging parameter values.

FIG. 13 shows schematically a coding scheme for dividing the plurality of pixels 20 row-wise into a first subset S1 having a first parameter value and a second subset S2 having a second parameter value. As shown on the left hand side of FIG. 13 during each specific time period (which corresponds here exemplarily to one clock cycle) the division into the two subsets is newly made. For example, the control unit 30 may indicate with a set flag or a bit value of “1”, which is represented by a black dot in FIG. 13, that the first parameter value is to be set in the respective row, while a non-set flag or a bit value of “0”, represented by a white dot in FIG. 13, triggers setting of the second parameter value in the respective row.

Thus, for each of the specific time periods a part of the pixel rows is able to generate image data by using the first parameter value. This corresponds to the ability to capture a part of the scene as illustrated on the right hand side of FIG. 13 by using the first parameter value, while the rest of the scene is captured with the second parameter value. In the next time step, the assignment changes, such that different parts of the scene are captured with the first and second parameter values, respectively.

The information captured during each specific time period for each pixel subset S1, S2 allows in principle reconstruction of the entire scene. In particular, since during a series of consecutive time periods most likely all pixels are operated with all parameter values at least once, the time series of the (partial) image data of each subset can be used to generate a series of image data of the entire scene for each parameter value. Moreover, temporal video regularities such as the absence of flickering in natural videos give additional constraints for image reconstruction.

Here, it is to be understood that the row-wise division is merely exemplarily. Also a column-wise or pixel-wise division can be applied, e.g. by using the row setting lines 23a and the column setting lines 24a or only the column setting lines 24a.

The control unit 30 is configured to gather the image data obtained via all subsets S1, S2 of pixels 20 during the specific time period and to carry out a predetermined processing. For example, the control unit 30 may reconstruct the full image data, i.e. generate final images F by using the image data. However, the control unit 30 may also perform object or gesture recognition, image classification or the like. In principle, any kind of processing to which the image data obtained via all subsets S1, S2 of pixels can constitute the predetermined processing. Thus, although in the following generation of final images F is predominantly discussed, this must not be considered as limiting, but merely as exemplary.

As explained above, during each of the specific time periods the optical device 10 captures different parts of the scene by applying different parameter values of at least one imaging parameter. Since the pixel subsets S1, S2 provide a representation of the scene that allows in principle to reconstruct the whole scene, one obtains a set of information that is equivalent to the information provided when capturing the scene with multiple optical devices to which the different parameter values are set. Thus, although using only a single optical device 10 and although the image capturing period is not extended, it is possible to carry out the predetermined processing as if several optical devices were used. This improves the quality of the predetermined processing compared to images obtained by using only a single parameter value, in particular if image reconstruction is concerned.

In this process the control unit 30 may also rely on information about the division of the plurality of pixels into the different subsets S1, S2 of pixels 20, e.g. in the form of a coding scheme or mask as illustrated in FIG. 13. For example, the control unit 30 stores flag or bit values used to control the circuitry 20a together with the image data output during the respective specific time period. Just the same, the circuitry 20a may output together with the image data of each pixel an indicator showing which parameter value(s) were used. In particular, a bit string encoding the parameter values of the adjustable imaging parameters may be output together with the photon count/the brightness detected by each pixel 20.

In this manner, the control unit 30 knows which part of the received image data was generated with which imaging setting. This will improve the usability of the data output for the predetermined processing.

While tuning imaging parameter values into one direction may lead to an improvement of the usability of the captured data for the predetermined processing in one regard, deterioration in another regard may occur. To mitigate this problem the control unit 30 may be configured to set the different parameter values such as to produce complementary image data in the different subsets S1, S2.

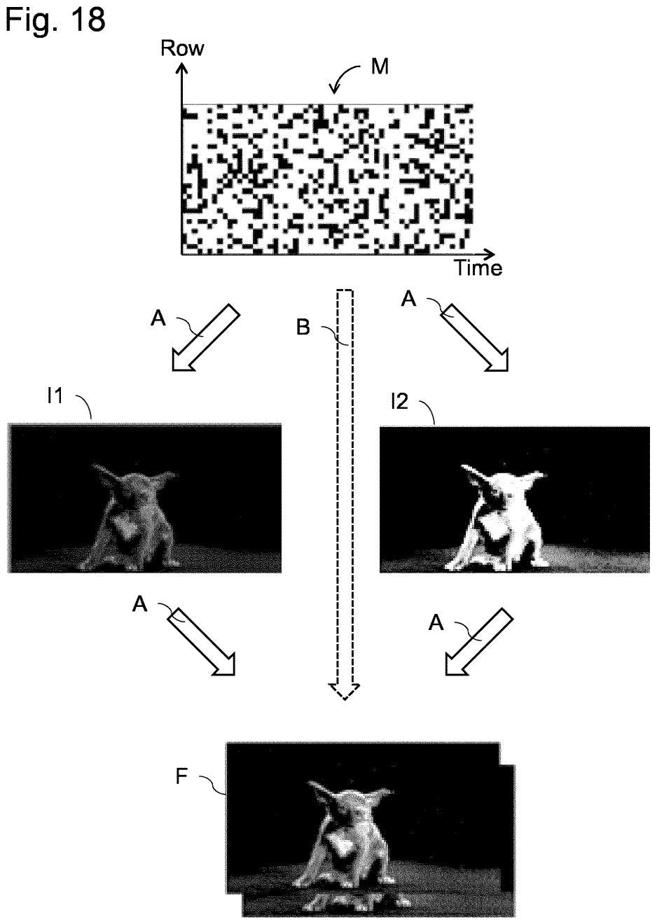

For example, the control unit may set a comparably short exposure time in a first subset S1 of pixels 20 and a comparably long exposure time in a second subset S2 of pixels 20. This will lead to comparably less brightness sensitive pixels 20 in the first subset S1, while the pixels 20 of the second subset S2 are comparably sensitive to brightness. A pair of resulting images is shown in the middle part of FIG. 18, where the left hand side shows an image reconstructed by using a short exposure time subset and the right hand side shows an image reconstructed by using a long exposure time subset. It can be seen that the right hand side is sensitive to bright regions, while the left hand side image is sensitive to dark regions.

By applying one (or more) such complementary reconstruction properties to different subsets of the pixels it is possible to correct the deficiencies present in the one image representation with the other image representation and vice versa. Accordingly, the following predetermined processing, e.g. image reconstruction, will suffer neither the deficiencies of the one image representation nor of the other (or shows these deficiencies only in attenuated form), as e.g. shown in the bottom part of FIG. 18.

As indicated schematically and exemplarily on the left hand side of FIG. 13, the control unit 30 may be configured to perform the division of the plurality of pixels 20 into the subsets S1, S2 of pixels 20 randomly. In particular, the control unit 30 may comprise a random number generator whose output for each pixel, row, or column determines the parameter value to be set. As shown in FIG. 13, flag or bit values (represented by black and white dots) may be set at the beginning of each specific time period according to the output of a random number generator, having e.g. an output of “0s” and “1s”. Since the assignment to which pixel subset each pixel 20 belongs is made on a random basis, it is ensured that the image capturing is not biased to a specific parameter value distribution. values to pixels 20, rows, or columns may also be not or not completely random. The control unit 30 may also be configured to perform the division of the plurality of pixels 20 into the subsets S1, S2 of pixels 20 at consecutive points in time based on an evaluation of the outcome of the predetermined processing that was carried out previously, e.g. an evaluation of previously generated final images F. In particular, the control unit 30 may be able to determine from the outcome of the previous processing steps how to assign parameter values to the pixels 20. Here, the control unit 30 may either set general criteria for assigning the parameter values, such as a bias to a random number generator or may specifically set the parameter values of each of the pixels 20 based on the evaluation of the outcome of the predetermined processing that was carried out previously.

In this manner, the control unit 30 is capable to adapt the assignment of imaging parameter values to specific conditions, like e.g. particularly bright or dark light conditions or the capturing of fast moving objects. This will improve the usability of the thus generated image data for the predetermined processing, while at the same time the amount of data generated by the optical device, i.e. the number of counted photons can be decreased.

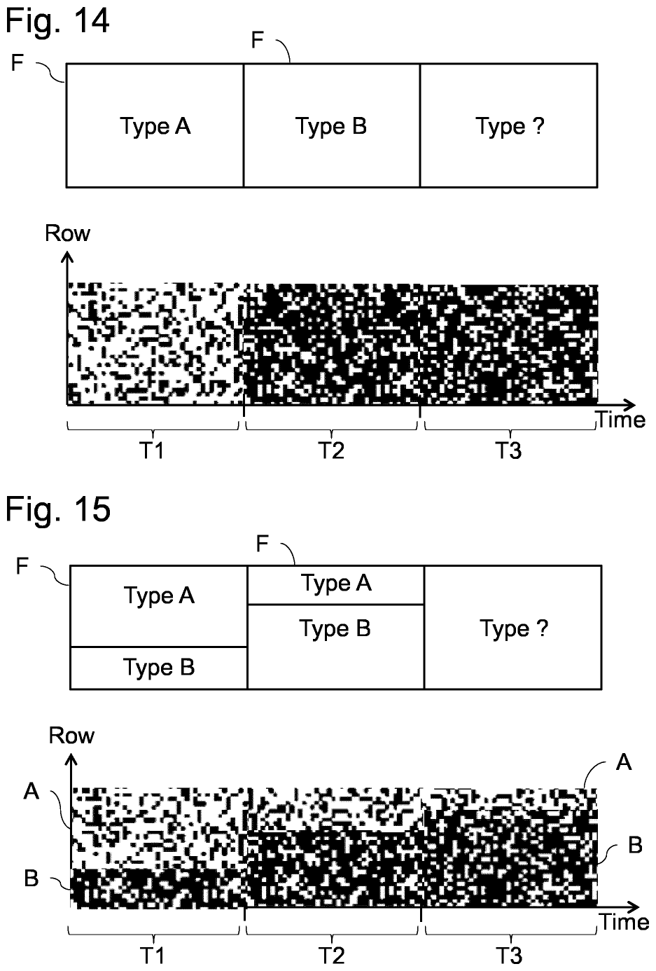

As schematically shown in FIG. 14 the control unit 30 may be configured to change the pixel ratio of the number of pixels 20 in the different subsets S1, S2 based on the evaluation of the outcome of the predetermined processing that was carried out previously. Here, during a first period T1, scenes of a first specific type, indicated as Type A, are captured. In this first period T1 parameter values are randomly assigned to pixels (represented in FIG. 14 exemplarily as row-wise assignment) with the boundary condition that the (if necessary temporally averaged) ratio of the number of pixels 20 in the first subset S1 to the number of pixels in the second subset S2 has a specific value. This may e.g. be achieved by randomly selecting only a given number pixels 20 to have a specific parameter value or by specifically choosing a set of pixels 20 to have the specific parameter value.

After period T1 a second period T2 follows in which a different scene type is observed, indicated as Type B. The control unit 30 is capable to determine the change of scene type after the period T1 and to change the number ratio of the pixels 20 in the different subsets. As indicated in FIG. 14 during the period T2 the number of pixels 20 assigned to the first subset S1 may be increased, while the distribution of according parameter values across the pixels 20 is still carried out randomly.

Finally, when image acquisition has exemplarily reached the end of period T2, the control unit 30 has to decide how to divide the pixels 20 in the future. To this end, the control unit 30 evaluates which scene types have been observed in the past (i.e. Type A and Type B) and deduces which scene type will be most probable in the future, represented in FIG. 14 by period T3. Then, the control unit 30 adjusts the assignment of parameter values to the pixels 20 accordingly.

In the example of FIG. 14, it is expected that also in period T3 scenes of Type B will be observed. Thus, the assignment of parameter values is continued as in period T2.

As illustrated in FIG. 15 this procedure can be extended such that the control unit 30 is configured to also segment the plurality of pixels 20 into different areas based on the evaluation of the outcome of the predetermined processing that was carried out previously, and to divide the pixels 20 in different areas according to different pixel ratios. Thus, the prediction which scheme of parameter value assignment is to be used for which pixels is extended from a purely temporal prediction to a spatiotemporal prediction.

This is schematically shown in FIG. 15 for a row-wise parameter value assignment. During period T1 a larger part of the final images F is of Type A, while a smaller part is of Type B. To deal with this situation the pixels 20 are grouped into corresponding areas A and B, in which different parameter value assignment schemes are applied. In the example of FIG. 15 the pixel rows in area A are divided into the first and the second subset according to a first number ratio, while for the rows in area B a different, second number ratio is used.

Period T1 is followed by period T2, in which the part of the scene that is of Type B has increased. Accordingly, also the area B in which the second number ratio is used has increased. Which parameter value assignment schemes are used best for which pixel areas for future image capturing in period T3 is predicted based on the outcome of the predetermined processing during periods T1 and T2. This is exemplarily indicated in FIG. 15 by a further extension of the area B in which division according to the second number ratio is applied, since it can be expected from the previous time periods T1 and T2 that the part of the scene belonging to type B further increases.

It has to be noted that the above separation into periods T1, T2, and T3 is exemplary and that the evaluation of the previous outcome of the predetermined processing is performed continuously by the control unit 30 such as to allow an adaption of the parameter value adjustment scheme at least in each of the specific time periods after which the parameter adjustment is changed anyhow. Thus, periods T1, T2 and T3 of FIGS. 14 and 15 might in fact have only a length of one or several specific time periods which are represented in FIGS. 14 and 15 by the temporal lengths of the black and white dots.

In the above description, it was assumed that the scene type will have a direct impact on the predetermined processing and the selection of the imaging parameters was hence done based on the observed scene type. this must not be understood as limiting. What determines the segmentation of imaging parameters is the whether or not it has to be expected based on previous time steps that a chosen segmentation/selection of imaging parameters will lead to a satisfactory outcome of the predetermined processing, and preferably also reduces the data amount generated by the optical device 10.

In the above process, the control unit 30 may evaluate the outcome of the predetermined processing that was carried out previously by using rule based algorithms that are e.g. able to recognize bright and dark parts or specific objects within an image. The adjustment of parameter values might then follow rules based on the recognized contents within the images. For example, for five mostly dark final images, it may be expected that also the next image will be dark. Further, for a fast moving object the speed may be deduced and pixels 20 corresponding to the expected position of the objection may be set to fitting imaging parameter values such as a

Preferably, the control unit 30 is configured to evaluate the outcome of the predetermined processing that was carried out previously by using a neuronal network that directly provides coded information for assigning parameter values (e.g. in the form of flags or bit strings) in the next time step based on the image data provided from the pixels 20 in the previous time step. Intuitively, such a network shall detect e.g. the scene type being imaged (e.g. cloudy day/night, fast moving object, hand gesture or the like) and then infer an optimal parameter value assignment for predetermined processing at hand for the next frame(s). This will improve the quality of the predetermined processing. The training of such network can be achieved by using a simulator of the image capturing properties of the optical device 10 that produces image data from different pixels subsets based on known images.

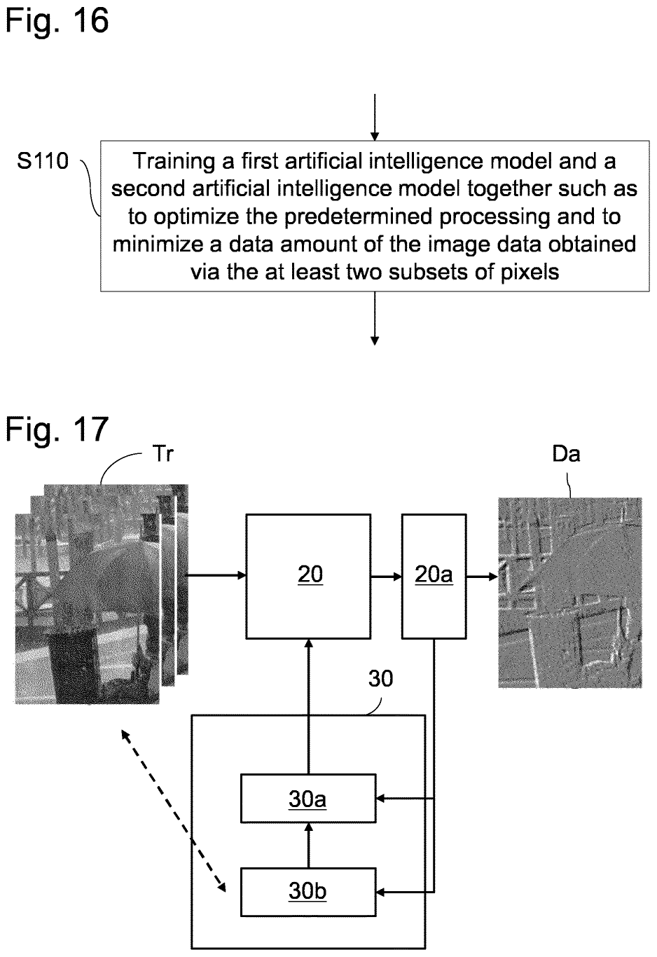

FIG. 16 shows schematically a process flow of a method for training an artificial intelligence model that can be used in the above manner. The artificial intelligence model comprises a first artificial intelligence model that is used to divide the plurality of pixels 20 into the subsets S1, S2 of pixels 20 at consecutive points in time and to set the parameter values of the imaging parameters and a second artificial intelligence model that is used to carry out the predetermined processing. The method comprises at S110 training the first artificial intelligence model and the second artificial intelligence model together such as to optimize the predetermined processing and to minimize a data amount of the image data obtained via the at least two subsets S1, S2 of pixels 20.

How the common training could be achieved is exemplary shown in FIG. 17. As shown in FIG. 17, the control unit 30 comprises the first artificial intelligence model 30a and the second artificial intelligence model 30b. Images of scenes are provided as training data Tr to the plurality of pixels 20 (or a simulation thereof) and produce SPAD data Da. These imaging data are provided to both, the first artificial intelligence model 30a and the second artificial intelligence model 30b. The first artificial intelligence model determines how to divide the pixels 20 into the different subsets S1, S2, and how to adjust the imaging parameters. This will of course influence the imaging data Da and their usability for the predetermined processing carried out by the second artificial intelligence model 30b.

The second artificial intelligence model 30b carries out the predetermined processing. For example, the outcome of the predetermined processing is evaluated in an in principle known manner against a loss function. If for example image reconstruction is the predetermined processing, evaluation can be based on the differences between the images reconstructed by the second artificial intelligence model 30b and the corresponding image out of the training data Tr.

The second artificial intelligence model 30b (or the control unit 30) reports the evaluation results to the first artificial intelligence model 30a. The first artificial intelligence model 30a is then able to change the applied imaging parameters based on the feedback provided from the second artificial intelligence model 30b. Further, as an additional constraint, the first artificial intelligence model 30a can be trained such as to minimize the data amount that is output as imaging data Da or as output of the second artificial intelligence model 30b (or both). Thus, a loss function against which the first artificial intelligence model 30a could be trained needs to take into account both, the loss function of the second artificial intelligence model 30b and a loss based on the generated data amount. The training aims then to reduce the combined loss of the first artificial intelligence model 30a and the second artificial intelligence model 30b.

The output of the neuronal network/the artificial intelligence model may either be a direct assignment of parameter values, i.e. a coding scheme as shown in FIGS. 13 to 15 that is, however, not produced by a random number generator, but at once by the neuronal network. Alternatively, the neuronal network may also only set the framework for the application of a random number generator, such as the number ratio to be reached.

As explained above, the principle idea for improving the outcome of the predetermined processing is to combine the image data generated based on signals of pixels 20 belonging to different pixel subsets S1, S2 to which different imaging parameter values are assigned.

In this process, the control unit 30 may be configured to generate for each of the specific time periods predetermined intermediate images 11, 12 for each subset S1, S2 of pixels 20 by using the image data generated by the pixels 20 of the respective subset S1, S2 of pixels 20. The predetermined processing can then operate on these intermediate images 11, 12. In particular, in image reconstruction, final images F can be generated by fusing intermediate images 11, 12 of different subsets S1, S2 of pixels 20.

This is exemplarily and schematically illustrated in FIG. 18. At the top of FIG. 18 a coding scheme/mask M is shown that assigns one of two parameter values to each pixel row, e.g. a comparably short exposure time and a comparably long exposure time.

From the image data obtained from pixels 20 using the one parameter value a first intermediate image I1 can be generated, e.g. by interpolating pixel values for pixels 20 belonging to the other subset. Just the same a second intermediate image 12 is generated from the image data of the pixels 20 using the other parameter value. The information of the respectively formed intermediate images 11, 12 is then used to improve the other image until possible deficiencies can be removed and the corresponding final image F is generated.

In the example of FIG. 18 the short exposure time leads to a comparably dark first intermediate image I1, which has, however, a higher temporal resolution. The long exposure time leads to the second intermediate image I2 that is comparably bright, but has less temporal resolution which leads might lead to motion blur. The final image F can then e.g. be obtained by fusing the images. In this manner a final image F with high dynamic range and reduced motion blur can be obtained, which would not have been possible with just one value of the exposure time.

According to the above described principles also more than two subsets of pixels 20 can be formed leading to more than two intermediate images that can then be fused using in principle known algorithms to produce a final image having the benefits of all image data captured with the differing image parameter values.

In FIG. 18 the above process follows the processing path indicated by arrows A. The same result can also be obtained by the control unit 30 by using an artificial intelligence model that receives the image data obtained via the at least two subsets S1, S2 of pixels 20 during the specific time period and that outputs the final images F (or the outcome of any other predetermined processing) directly. This is symbolized by arrow B in FIG. 18. For image reconstruction, the used artificial intelligence model may be a model-aware neural network designed to optimally decode and fuse images. Such model-aware neural networks are described e.g. in “Deep variational network for rapid 4D flow MRI reconstruction” by Vishnevskiy V, Walheim J, Kozerke S. (Nat Mach Intell 2, 228-235 (2020). https://doi.org/10.1038/s42256-020-0165-6) and “Deep variational networks with exponential weighting for learning computed tomography” by Vishnevskiy V, Rau R, Goksel O (In: Shen D. et al. (eds) Medical Image Computing and Computer Assisted Intervention—MICCAI 2019; MICCAI 2019; Lecture Notes in Computer Science, vol 11769. Springer, Cham. https://doi.org/10.1007/978-3-030-32226-7_35), which are incorporated for reference here as far as model-aware neural networks are concerned.

In this manner performing the predetermined processing, such as e.g. the generation of final image F, can be achieved with low processing burden once a sufficiently trained artificially intelligence model is implemented in the control unit 30. Again, the model can be trained by using a simulation of the optical device 10. The training may be done as described above with respect to FIGS. 16 and 17 such that also the amount of data generated by the SPADs of the pixels 20 is reduced by the selection of imaging parameters.

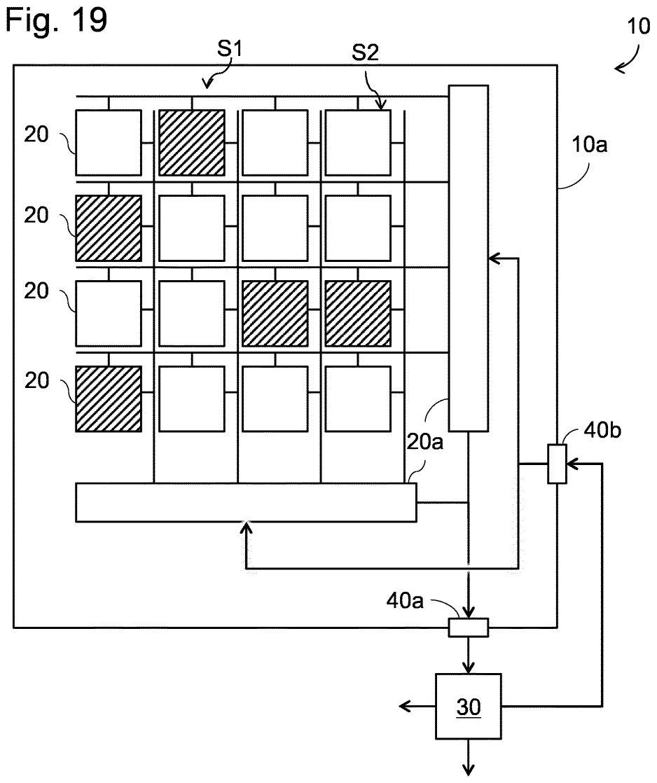

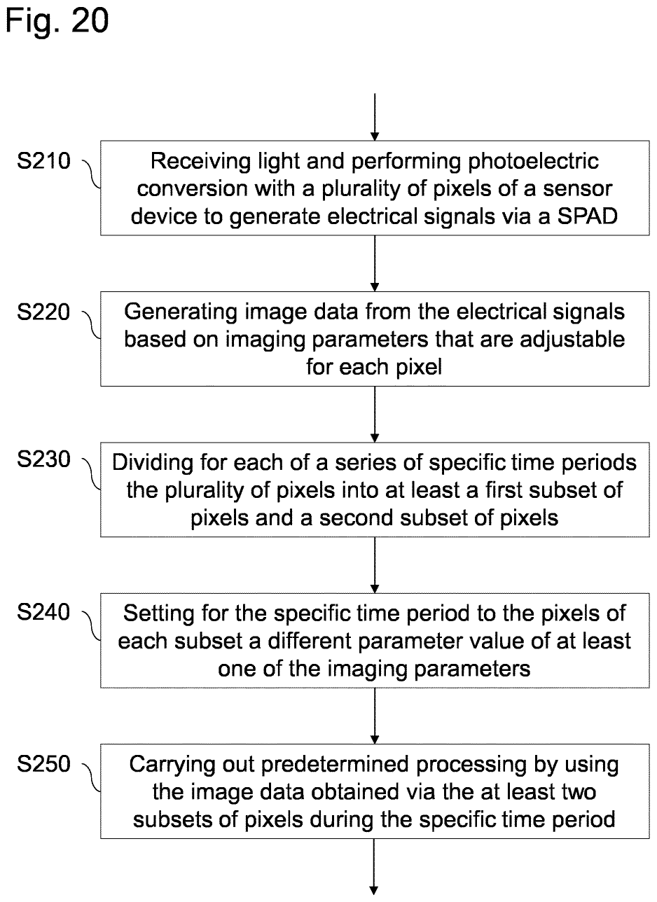

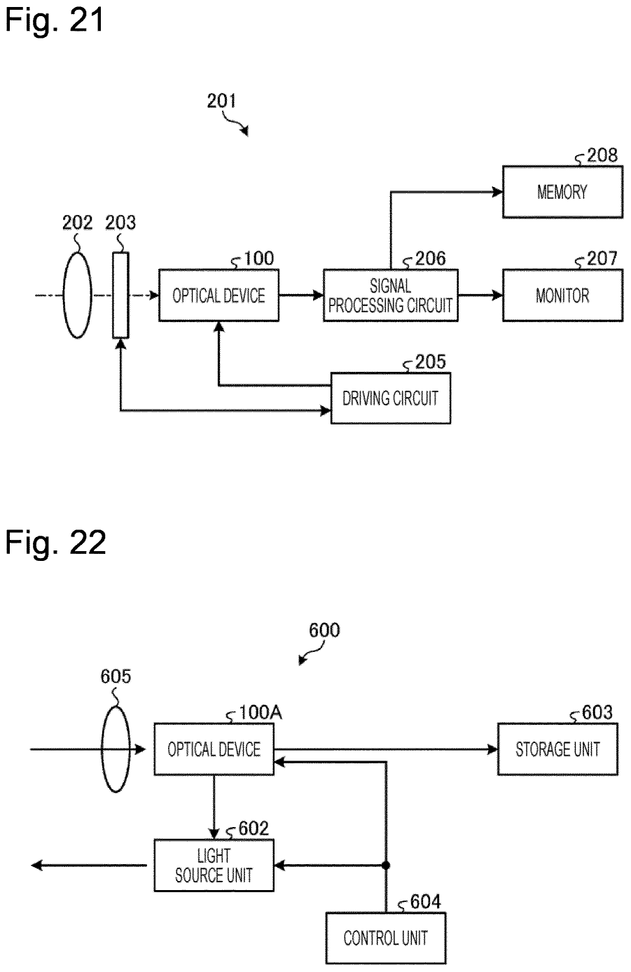

As illustrated in FIG. 21 FIG. 19 the pixels 20 and the circuitry 20a may be arranged on a sensor chip 10a as is in principle known to a skilled person. However, instead of having only a single (first) port 40a for outputting the image data from the sensor chip 10a, the sensor chip 10a may comprise a second port 40b for inputting control information like a coding scheme for controlling the division of the plurality of pixels 20 into the at least two subsets S1, S2 of pixels 20 and the parameter values of the at least one imaging parameter.

In this configuration the control unit 30 is arranged outside the sensor chip 10a, e.g. on a different chip or in an external device. The control unit 30 receives the image data and, if necessary, the assignment of parameter values to pixels 20 to generate the final images. Further, the control unit 30 produces the control information that assigns the pixels 20 to the different subsets S1, S2, like e.g. the output of the (biased) random number generator or a fixed coding scheme, which is fed via the second port 40b to the circuitry to set therein the desired values of the imaging parameters. Of course, the control unit 30 could also be located on the sensor chip 10a. In this case, the second port 40b could be used to connect an external random number generator to the control unit 30 that uses the generated random numbers to divide the pixels 20 into the various subsets S1, S2.

Above various implementations of the basic idea to capture an image by using simultaneously different imaging parameter values in a single SPAD pixel array has been discussed. The basic method underlying all these implementations is again summarized below with respect to FIG. 22 FIG. 21.

Here, at S210 light is received and photoelectric conversion is performed with a plurality of pixels 20 of the optical device 10 to generate an electrical signal via the SPADs in the pixels 20.

At S102 circuitry 20a of the optical device 10 is used to generate image data from the electrical signals based on imaging parameters that are adjustable for each pixel 20.

At S103 for each of a series of specific time periods the plurality of pixels 20 are divided into at least a first subset S1 of pixels 20 and a second subset S2 of pixels 20.

At S104 for each specific time period a different parameter value of at least one of the imaging parameters is set to the pixels 20 of each subset S1, S2.

At S105 a predetermined processing is carried out by using the image data obtained via the at least two subsets S1, S2 of pixels 20 during the respective specific time period.

Thus, the basic idea is to obtain the information available for different imaging parameter values within a single capturing period and to use this information for solving a particular task in an improved manner that would not be possible when only a single imaging parameter value is applied. Moreover, by selecting imaging parameters appropriately, preferably via an artificial intelligence model, the data amount generated by the pixels 20 can be reduced. In this manner the quality of solution provided for the task at hand can be improved while at the same time a reduction of the data amount can be achieved.

The optical device described above can be applied to, for example, various electronic apparatuses such as an imaging apparatus such as a digital still camera or a digital video camera, a mobile phone having an imaging function, or another device having an imaging function.

FIG. 21 is a block diagram illustrating a configuration example of an imaging apparatus as an electronic apparatus to which the present technology is applied. An imaging apparatus 201 illustrated in FIG. 21 includes an optical system 202, a shutter device 203, an optical device 10, a driving circuit 205, a signal processing circuit 206, a monitor 207, and a memory 208, and can capture a still image and a moving image.

The optical system 202 includes one or a plurality of lenses, guides light (incident light) from a subject to the optical device 10, and forms an image on a light receiving surface of the optical device 10.

The shutter device 203 is arranged between the optical system 202 and the optical device 10, and controls a light irradiation period and a light shielding period with respect to the optical device 10 according to the control of the driving circuit 205.

The driving circuit 205 outputs a driving signal for controlling the transfer operation of the optical device 10 and the shutter operation of the shutter device 203 to drive the optical device 10 and the shutter device 203.

The optical device 10 includes a light receiving element (pixel) including an SPAD as described above. For application to the imaging apparatus, the optical device 10 includes a digital counter circuit 240 (FIG. 4B) at the output end of the readout circuit 230. Under the control of the driving circuit 205, the optical device 10 counts the number of photons for every pixel by the digital counter circuit 240 depending on light formed on the light receiving surface through the optical system 202 and the shutter device 203 during a predetermined exposure period. The count number is converted into a luminance signal and transferred to the column circuit 310 through the bit line BL according to the selection signal supplied from the row scanning circuit 320 (FIG. 4A) to the word line WL of each pixel under the control of the driving circuit 205. The column circuit 310 converts the luminance signal from each pixel into a digital signal, and the converted digital signal is output to the signal processing circuit 206 through the interface circuit 330.

The signal processing circuit 206 performs various signal processing on the digital signal output from the optical device 10. An image (image data) obtained by performing the signal processing by the signal processing circuit 206 is supplied to and displayed on the monitor 207, or supplied to and stored (recorded) in the memory 208.

In the imaging apparatus 201 configured as described above, since the optical device 10 includes the light receiving element as described above, the imaging apparatus 201 can also exhibit the effects of reducing the dead time and reducing the power consumption. Note that a color filter may be provided on the light receiving surface of the optical device 10. In the color filter, a red filter that transmits red wavelength region light, a green filter that transmits green wavelength region light, and a blue filter that transmits blue wavelength light are formed corresponding to the light receiving elements (pixels) of the optical device 10. For example, a Bayer filter is exemplified as the color filter. By using such a color filter, the imaging apparatus 201 can be configured as an imaging apparatus capable of acquiring a color image.

Next, as the electronic apparatus to which an optical device 10 as described above may be applied due to presence of the SAPDs, a distance measurement apparatus that performs distance measurement by the direct ToF method will be described. FIG. 22 is a block diagram illustrating a configuration example of a distance measurement apparatus 600. As illustrated, the distance measurement apparatus 600 includes an optical device 100A, a light source unit 602, a storage unit 603, a distance control unit 604, and an optical system 605.

The light source unit 602 may be, for example, a vertical cavity surface emitting laser (VCSEL) array that emits laser light as a surface light source. However, the light source unit 602 may be a laser diode array in which laser diodes are arranged on a line. In this case, the laser diode array is supported by a predetermined driving unit (not illustrated), and is scanned in a direction perpendicular to the arrangement direction of the laser diodes. Further, the light source unit 602 may be a single laser diode. In this case, the single laser diode is supported by a predetermined driving unit (not illustrated), and is scanned horizontally and vertically.

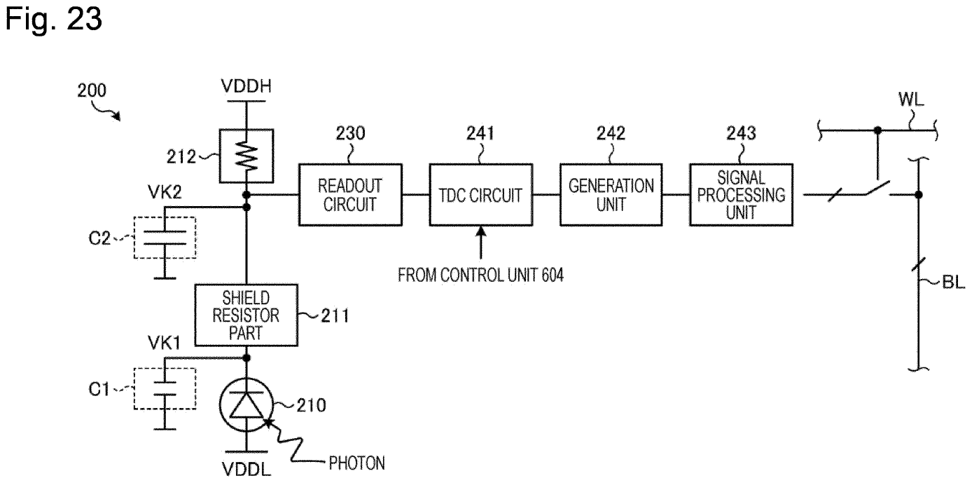

In the example of FIG. 23, the optical device 100A includes a TDC circuit 241, a generation unit 242, and a signal processing unit 243 sequentially connected in series to the output end of the readout circuit 230, as illustrated in FIG. 23, instead of the digital counter circuit 240 (FIG. 4B) described above. The functions of the TDC circuit 241, the generation unit 242, and the signal processing unit 243 will be described later.

The signal processing unit 243 performs predetermined calculation processing on the basis of data of a histogram (described later) generated by the generation unit 242, and calculates, for example, distance information. For example, the signal processing unit 243 creates curve approximation of the histogram on the basis of the data of the histogram generated by the generation unit 242. The signal processing unit 243 can detect a peak of a curve approximated by the histogram and obtain a distance D on the basis of the detected peak.

The storage unit 603 (FIG. 22) includes, for example, a flash memory, a DRAM, an SRAM, or the like, and stores data or the like input from the optical device 10.

The distance control unit 604 controls the entire operation of the distance measurement apparatus 600. For example, the distance control unit 604 supplies a predetermined reference signal having a predetermined frequency to the optical device 10 and the light source unit 602. The light source unit 602 emits pulsed light on the basis of a reference signal supplied from the distance control unit 604, for example. For example, the optical device 10 obtains the time difference between a light emission timing and a light reception timing on the basis of the reference signal described above and the output signal output from the readout circuit 230. Further, the distance control unit 604 sets a pattern at the time of distance measurement for the optical device 10 in response to an instruction from the outside, for example.

The optical system 605 guides light incident from the outside to the light receiving surface of the optical device 10.

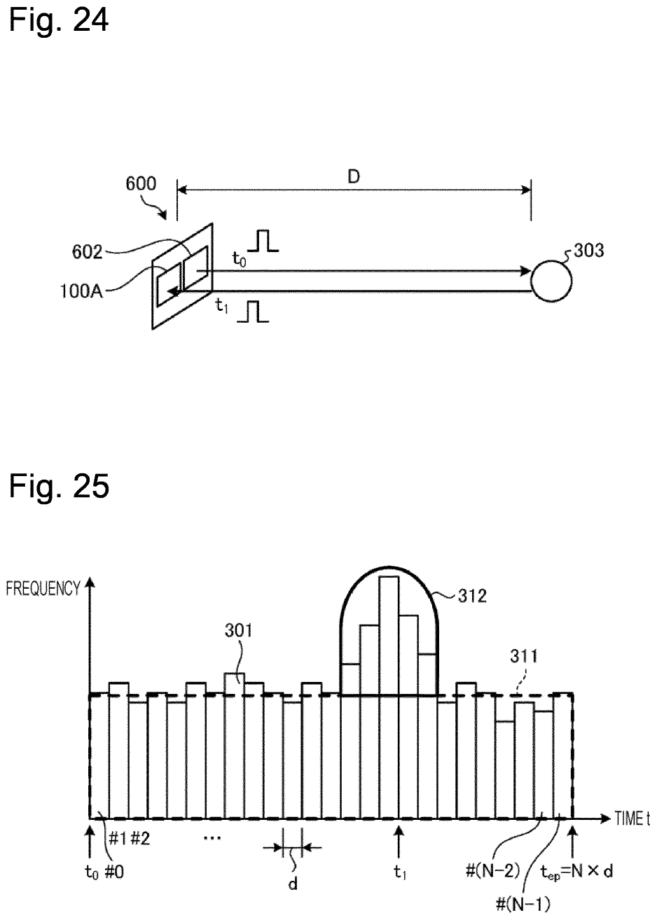

Next, with reference to FIG. 24, as an example of distance measurement by the distance measurement apparatus 600, distance measurement by the direct ToF method will be described using a case where the distance measurement apparatus 600 measures the distance D from the distance measurement apparatus 600 to a measurement object 303 as an example. A time at which the light source unit 602 emits light is defined as a light emission timing t₀, and a time at which the optical device 10 receives reflected light obtained by reflecting the light emitted from the light source unit 602 by the measurement object 303 is defined as a light reception timing t₁. At this time, the distance D between the distance measurement apparatus 600 and the measurement object 303 can be calculated by the following Expression (1).

D=(c/2)×(t₁−t₀) (1)

Here, the Constant C Is a Light Velocity (2.9979×10⁸ [m/sec]).

Incidentally, in the optical device 100A, when light (photon) is incident on the pixel 200, even if the light is light other than the reflected light (for example, ambient light) from the measurement object 303, an output signal is output from the readout circuit 230, and light reception timing is calculated by the TDC circuit 241 as described later. That is, the light reception timing t₁ calculated on the basis of the reflected light from the measurement object 303 and the light reception timing calculated on the basis of the light other than the reflected light cannot be distinguished.

Accordingly, in the distance measurement apparatus 600, light is repeatedly emitted from the light source unit 602 (for example, several 10 to several tens of thousands of times), and a histogram relating to a difference between the light emission timing and the light reception timing is created. FIG. 25 is a diagram illustrating an example of the histogram created in this manner. As illustrated, the number of times (frequency) 301 of the light reception timing is illustrated for each of the sections #0, #1, #2, . . . , #(N−2), and #(N−1) having a predetermined unit time d. Here, the section #0 is a range of the time d from the light emission timing t₀, and the section #1 is a range of the time d from a time point when the time d has elapsed from the light emission timing t₀. Note that, in the drawing, a period from the light emission timing t₀ to tₑₚ corresponds to the exposure time of the optical device 10.

Referring to FIG. 25, there is a section (hereinafter referred to as a section 312 for convenience) in which the number of light reception timings protrudes as compared with the adjacent section, as indicated by a curve 312, as compared with a range 311 indicated by a broken line. While the ambient light and the like are received randomly, the light emitted from the light source unit 602 and reflected by the measurement object 303 is received after the light is propagated by the distance of 2×D, and thus may occur when a certain range of time has elapsed although an error is included. Thus, the light reception timing t₁ corresponding to the reflected light from the measurement object 303 is considered to be included in the section 312. Accordingly, for example, as illustrated in the drawing, the end point of the section in which the maximum number of light reception timings in the section 312 is recorded can be set as the light reception timing t₁ based on the reflected light from the measurement object 303. The start time point or the center time point of the section in which the maximum number of light reception timings is recorded may be set as the light reception timing t₁. Further, in the section 312, an approximate curve of the number of light emission timings may be obtained, and the light emission timing ti may be obtained on the basis of a peak value thereof.

As described above, the light reception timing t₁ of the reflected light from the measurement object 303 can be obtained, and the distance D to the measurement object 303 can be calculated by Expression (1).

In a case where the above-described distance measurement by the direct ToF method is performed in the optical device 100A, the light reception timing is obtained by the TDC circuit 241. That is, the TDC circuit 241 generates a time difference signal indicating a time difference between the reference signal input from the distance control unit 604 and the output signal from the readout circuit 230. The reference signal from the distance control unit 604 is also input to the light source unit 602, and the light source unit 602 emits pulsed light on the basis of the reference signal. Thus, from the time difference signal generated in the TDC circuit 241, it is possible to obtain the light reception timing with reference to the light emission timing t₀ at which the light source unit 602 emits the pulsed light.

The light emission based on the reference signal by the light source unit 602 and the light reception by the SPAD 210 are repeated, and a histogram relating to a difference between the light emission timing and the light reception timing obtained by the TDC circuit 241 is generated by the generation unit 242 every time. On the basis of the histogram created by the generation unit 242, the signal processing unit 243 determines the light reception timing t₁ and calculates the distance D.

The technology according to the present disclosure (the present technology) can be applied to various products. For example, the technology according to the present disclosure may be applied to an endoscopic surgery system.

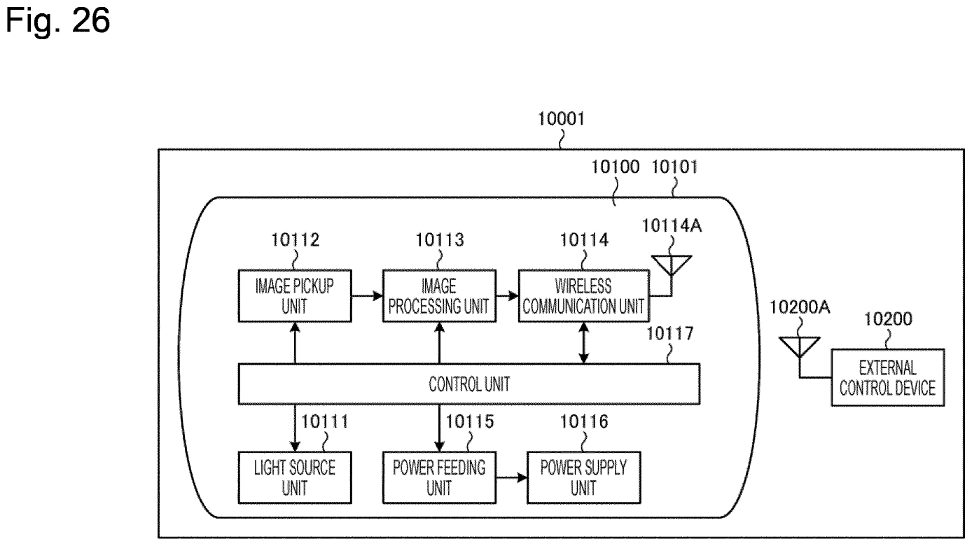

FIG. 26 is a block diagram illustrating an example of a schematic configuration of a patient in-vivo information acquisition system using a capsule type endoscope to which the technology according to the present disclosure (present technology) can be applied.

The in-vivo information acquisition system 10001 includes a capsule type endoscope 10100 and an external control device 10200.

The capsule type endoscope 10100 is swallowed by a patient at the time of examination. The capsule type endoscope 10100 has an imaging function and a wireless communication function and, while moving inside an organ such as a stomach and an intestine by peristaltic movement or the like until it is naturally excreted from the patient, sequentially captures images inside the organ (hereinafter also referred to as in-vivo images) at predetermined intervals, and sequentially transmits information regarding the in-vivo images wirelessly to the external control device 10200 outside the body.

The external control device 10200 integrally controls the operation of the in-vivo information acquisition system 10001. Further, the external control device 10200 receives information regarding the in-vivo images transmitted from the capsule type endoscope 10100, and generates image data for displaying the in-vivo images on a display apparatus (not illustrated) on the basis of the received information regarding the in-vivo images.

In the in-vivo information acquisition system 10001, in this manner, it is possible to obtain an in-vivo image obtained by imaging an in-vivo state of the body of the patient at any time from the time when the capsule type endoscope 10100 is swallowed until it is discharged.

Configurations and functions of the capsule type endoscope 10100 and the external control device 10200 will be described in more detail.

The capsule type endoscope 10100 includes a capsule type housing 10101, and a light source unit 10111, an image pickup unit 10112, an image processing unit 10113, a wireless communication unit 10114, a power feeding unit 10115, a power supply unit 10116, and a control unit 10117 are housed in the housing 10101.

The light source unit 10111 includes a light source such as a light emitting diode (LED), for example, and irradiates an imaging field of view of the image pickup unit 10112 with light.

The image pickup unit 10112 includes an image pickup element and an optical system including a plurality of lenses provided in front of the image pickup element. Reflected light (hereinafter referred to as observation light) of light emitted to a body tissue that is an observation target is condensed by the optical system and is incident on the image pickup element. In the image pickup unit 10112, the observation light incident on the image pickup element is photoelectrically converted, and an image signal corresponding to the observation light is generated. The image signal generated by the image pickup unit 10112 is provided to the image processing unit 10113.

The image processing unit 10113 includes a processor such as a central processing unit (CPU) or a graphics processing unit (GPU), and performs various signal processing on the image signal generated by the image pickup unit 10112. The image processing unit 10113 provides the image signal subjected to the signal processing to the wireless communication unit 10114 as RAW data.

The wireless communication unit 10114 performs predetermined processing such as modulation processing on the image signal that has been subjected to the signal processing by the image processing unit 10113, and transmits the image signal to the external control device 10200 via the antenna 10114A. Further, the wireless communication unit 10114 receives a control signal related to drive control of the capsule type endoscope 10100 from the external control device 10200 via the antenna 10114A. The wireless communication unit 10114 provides the control unit 10117 with the control signal received from the external control device 10200.

The power feeding unit 10115 includes a power receiving antenna coil, a power regeneration circuit that regenerates power from a current generated in the antenna coil, a booster circuit, and the like. In the power feeding unit 10115, power is generated using what is called non-contact charging principle.

The power supply unit 10116 includes a secondary battery, and stores the power generated by the power feeding unit 10115. In FIG. 26, in order to avoid complication of the drawing, illustration of an arrow or the like indicating a supply destination of power from the power supply unit 10116 is omitted, but the power stored in the power supply unit 10116 is supplied to the light source unit 10111, the image pickup unit 10112, the image processing unit 10113, the wireless communication unit 10114, and the control unit 10117, and can be used for driving these units.

The control unit 10117 includes a processor such as a CPU, and appropriately controls driving of the light source unit 10111, the image pickup unit 10112, the image processing unit 10113, the wireless communication unit 10114, and the power feeding unit 10115 according to the control signal transmitted from the external control device 10200.

The external control device 10200 includes a processor such as a CPU or GPU, or a microcomputer or a control board or the like on which a processor and a storage element such as a memory are mounted in a mixed manner. The external control device 10200 controls the operation of the capsule type endoscope 10100 by transmitting the control signal to the control unit 10117 of the capsule type endoscope 10100 via the antenna 10200A. In the capsule type endoscope 10100, for example, the control signal from the external control device 10200 can change irradiation conditions of light with respect to the observation target in the light source unit 10111.

Further, imaging conditions (for example, a frame rate, an exposure value, and the like in the image pickup unit 10112) can be changed by the control signal from the external control device 10200. Further, the contents of processing in the image processing unit 10113 and conditions for transmitting the image signal by the wireless communication unit 10114 (for example, transmission interval, number of transmitted images, and the like) may be changed by the control signal from the external control device 10200.

Further, the external control device 10200 performs various image processing on the image signal transmitted from the capsule type endoscope 10100, and generates image data for displaying the captured in-vivo image on the display apparatus. As the image processing, for example, various signal processing such as development processing (demosaic processing), image quality enhancement processing (band enhancement processing, super-resolution processing, noise reduction (NR) processing, and/or camera shake correction processing, and the like), and/or enlargement processing (electronic zoom processing) and the like can be performed. The external control device 10200 controls driving of the display apparatus to display the in-vivo image captured on the basis of the generated image data. Alternatively, the external control device 10200 may have the generated image data recorded in a recording device (not illustrated) or printed out by a printing device (not illustrated).

The example of the in-vivo information acquisition system to which the technology according to the present disclosure can be applied has been described above. The technology according to the present disclosure can be applied to the image pickup unit 10112 among the configurations described above. Specifically, the optical device as described above can be used as the image pickup unit 10112. According to the above-described optical device, it is possible to reduce the dead time of the SPAD 210 (or 210A). Therefore, if an optical device is used as the image pickup unit 10112, the imaging interval by the capsule type endoscope 10100 can be appropriately set. That is, it is possible to reduce the possibility that the SPAD 210 (or 210A) is in the dead time at the time of imaging by the capsule type endoscope 10100. Further, since the power consumption of the SPAD 210 can be reduced, the optical device 100 and the like can be reliably operated until the capsule type endoscope 10100 is naturally discharged after being swallowed by the patient.

Note that although the patient in-vivo information acquisition system using the capsule type endoscope has been described here, the technology according to the present disclosure may be applied to, for example, an endoscopic surgery system. Hereinafter, a case where the technology of the present disclosure is applied to an endoscopic surgery system will be described.

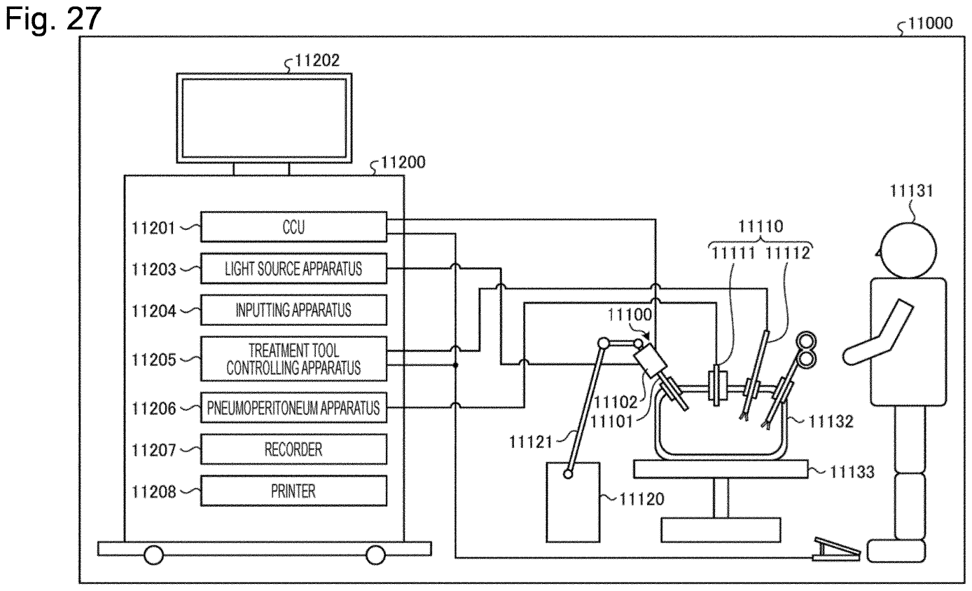

FIG. 27 is a diagram illustrating an example of a schematic configuration of an endoscopic surgery system to which the technology according to the present disclosure (present technology) can be applied.

In FIG. 27, a state is illustrated in which a surgeon (medical doctor) 11131 is using an endoscopic surgery system 11000 to perform surgery for a patient 11132 on a patient bed 11133. As illustrated, the endoscopic surgery system 11000 includes an endoscope 11100, other surgical tools 11110 such as a pneumoperitoneum tube 11111 and an energy device 11112, a supporting arm apparatus 11120 which supports the endoscope 11100 thereon, and a cart 11200 on which various apparatus for endoscopic surgery are mounted.

The endoscope 11100 includes a lens barrel 11101 having a region of a predetermined length from a distal end thereof to be inserted into a body cavity of the patient 11132, and a camera head 11102 connected to a proximal end of the lens barrel 11101. In the example illustrated, the endoscope 11100 is illustrated which includes as a rigid endoscope having the lens barrel 11101 of the hard type. However, the endoscope 11100 may otherwise be included as a flexible endoscope having the lens barrel of the flexible type.

The lens barrel 11101 has, at a distal end thereof, an opening in which an objective lens is fitted. A light source apparatus 11203 is connected to the endoscope 11100 such that light generated by the light source apparatus 11203 is introduced to a distal end of the lens barrel by a light guide extending in the inside of the lens barrel 11101 and is emitted toward an observation target in a body cavity of the patient 11132 through the objective lens. It is to be noted that the endoscope 11100 may be a forward-viewing endoscope or may be an oblique-viewing endoscope or a side-viewing endoscope.

An optical system and an image pickup element are provided in the inside of the camera head 11102 such that reflected light (observation light) from the observation target is condensed on the image pickup element by the optical system. The observation light is photo-electrically converted by the image pickup element to generate an electric signal corresponding to the observation light, namely, an image signal corresponding to an observation image. The image signal is transmitted as RAW data to a camera control unit (CCU) 11201.

The CCU 11201 includes a central processing unit (CPU), a graphics processing unit (GPU), or the like and integrally controls operation of the endoscope 11100 and a display apparatus 11202. Moreover, the CCU 11201 receives an image signal from the camera head 11102 and performs, for the image signal, various image processes for displaying an image based on the image signal such as, for example, a development process (demosaic process).

The display apparatus 11202 displays thereon an image based on an image signal, for which the image processes have been performed by the CCU 11201, under the control of the CCU 11201.

The light source apparatus 11203 includes a light source such as, for example, a light emitting diode (LED) and supplies irradiation light upon imaging of a surgical region to the endoscope 11100.

An inputting apparatus 11204 is an input interface for the endoscopic surgery system 11000. A user can perform inputting of various kinds of information or instruction inputting to the endoscopic surgery system 11000 through the inputting apparatus 11204. For example, the user would input an instruction or a like to change an image pickup condition (type of irradiation light, magnification, focal distance or the like) by the endoscope 11100.

A treatment tool controlling apparatus 11205 controls driving of the energy device 11112 for cautery or incision of a tissue, sealing of a blood vessel or the like. A pneumoperitoneum apparatus 11206 feeds gas into a body cavity of the patient 11132 through the pneumoperitoneum tube 11111 to inflate the body cavity in order to secure the field of view of the endoscope 11100 and secure the working space for the surgeon. A recorder 11207 is an apparatus capable of recording various kinds of information relating to surgery. A printer 11208 is an apparatus capable of printing various kinds of information relating to surgery in various forms such as a text, an image or a graph.

It is to be noted that the light source apparatus 11203 which supplies irradiation light when a surgical region is to be imaged to the endoscope 11100 may include a white light source which includes, for example, an LED, a laser light source or a combination of them. Where a white light source includes a combination of red, green, and blue (RGB) laser light sources, since the output intensity and the output timing can be controlled with a high degree of accuracy for each color (each wavelength), adjustment of the white balance of a picked up image can be performed by the light source apparatus 11203. Further, in this case, if laser beams from the respective RGB laser light sources are emitted time-divisionally on an observation target and driving of the image pickup elements of the camera head 11102 are controlled in synchronism with the emission timings. Then images individually corresponding to the R, G, and B colors can be also picked up time-divisionally. According to this method, a color image can be obtained even if color filters are not provided for the image pickup element.

Further, the light source apparatus 11203 may be controlled such that the intensity of light to be outputted is changed for each predetermined time. By controlling driving of the image pickup element of the camera head 11102 in synchronism with the timing of the change of the intensity of light to acquire images time-divisionally and synthesizing the images, an image of a high dynamic range free from underexposed blocked up shadows and overexposed highlights can be created.

Further, the light source apparatus 11203 may be configured to supply light of a predetermined wavelength band ready for special light observation. In special light observation, for example, by utilizing the wavelength dependency of absorption of light in a body tissue to emit light of a narrow band in comparison with irradiation light upon ordinary observation (namely, white light), narrow band observation (narrow band imaging) of imaging a predetermined tissue such as a blood vessel of a superficial portion of the mucous membrane or the like in a high contrast is performed. Alternatively, in special light observation, fluorescent observation for obtaining an image from fluorescent light generated by irradiation with excitation light may be performed. In fluorescent observation, it is possible to perform observation of fluorescent light from a body tissue by emitting excitation light on the body tissue (autofluorescence observation) or to obtain a fluorescent light image by locally injecting a reagent such as indocyanine green (ICG) into a body tissue and emitting excitation light corresponding to a fluorescent light wavelength of the reagent upon the body tissue. The light source apparatus 11203 can be configured to supply such narrow-band light and/or excitation light suitable for special light observation as described above.

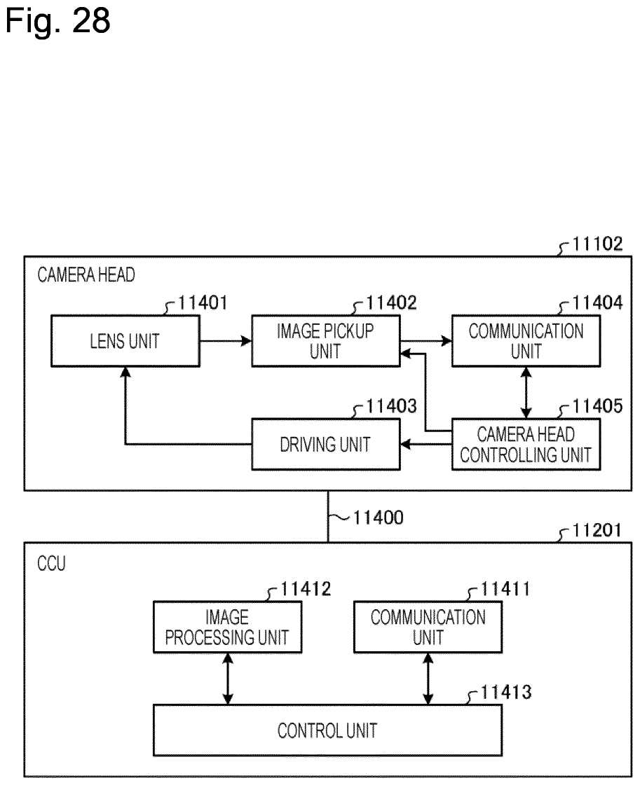

FIG. 28 is a block diagram illustrating an example of a functional configuration of the camera head 11102 and the CCU 11201 illustrated in FIG. 27.

The camera head 11102 includes a lens unit 11401, an image pickup unit 11402, a driving unit 11403, a communication unit 11404, and a camera head controlling unit 11405. The CCU 11201 includes a communication unit 11411, an image processing unit 11412, and a control unit 11413. The camera head 11102 and the CCU 11201 are connected for communication to each other by a transmission cable 11400.

The lens unit 11401 is an optical system, provided at a connecting location to the lens barrel 11101. Observation light taken in from a distal end of the lens barrel 11101 is guided to the camera head 11102 and introduced into the lens unit 11401. The lens unit 11401 includes a combination of a plurality of lenses including a zoom lens and a focusing lens.

The image pickup unit 11402 includes an image pickup element. The number of image pickup elements which is included by the image pickup unit 11402 may be one (single-plate type) or a plural number (multi-plate type). Where the image pickup unit 11402 is configured as that of the multi-plate type, for example, image signals corresponding to respective R, G, and B are generated by the image pickup elements, and the image signals may be synthesized to obtain a color image. The image pickup unit 11402 may also be configured so as to have a pair of image pickup elements for acquiring respective image signals for the right eye and the left eye ready for three dimensional (3D) display. If 3D display is performed, then the depth of a living body tissue in a surgical region can be comprehended more accurately by the surgeon 11131. It is to be noted that, in a case where the image pickup unit 11402 is configured as that of stereoscopic type, a plurality of systems of lens units 11401 is provided corresponding to the individual image pickup elements.

Further, the image pickup unit 11402 may not necessarily be provided on the camera head 11102. For example, the image pickup unit 11402 may be provided immediately behind the objective lens in the inside of the lens barrel 11101.

The driving unit 11403 includes an actuator and moves the zoom lens and the focusing lens of the lens unit 11401 by a predetermined distance along an optical axis under the control of the camera head controlling unit 11405. Consequently, the magnification and the focal point of a picked up image by the image pickup unit 11402 can be adjusted suitably.

The communication unit 11404 includes a communication apparatus for transmitting and receiving various kinds of information to and from the CCU 11201. The communication unit 11404 transmits an image signal acquired from the image pickup unit 11402 as RAW data to the CCU 11201 through the transmission cable 11400.

In addition, the communication unit 11404 receives a control signal for controlling driving of the camera head 11102 from the CCU 11201 and supplies the control signal to the camera head controlling unit 11405. The control signal includes information relating to image pickup conditions such as, for example, information that a frame rate of a picked up image is designated, information that an exposure value upon image picking up is designated, and/or information that a magnification and a focal point of a picked up image are designated.

It is to be noted that the image pickup conditions such as the frame rate, exposure value, magnification or focal point may be designated by the user or may be set automatically by the control unit 11413 of the CCU 11201 on the basis of an acquired image signal. In the latter case, an auto exposure (AE) function, an auto focus (AF) function and an auto white balance (AWB) function are incorporated in the endoscope 11100.

The camera head controlling unit 11405 controls driving of the camera head 11102 on the basis of a control signal from the CCU 11201 received through the communication unit 11404.

The communication unit 11411 includes a communication apparatus for transmitting and receiving various kinds of information to and from the camera head 11102. The communication unit 11411 receives an image signal transmitted thereto from the camera head 11102 through the transmission cable 11400.

Further, the communication unit 11411 transmits a control signal for controlling driving of the camera head 11102 to the camera head 11102. The image signal and the control signal can be transmitted by electrical communication, optical communication, or the like.

The image processing unit 11412 performs various image processes for an image signal in the form of RAW data transmitted thereto from the camera head 11102.

The control unit 11413 performs various kinds of control relating to image picking up of a surgical region or the like by the endoscope 11100 and display of a picked up image obtained by image picking up of the surgical region or the like. For example, the control unit 11413 creates a control signal for controlling driving of the camera head 11102.

Further, the control unit 11413 causes, on the basis of an image signal for which image processes have been performed by the image processing unit 11412, the display apparatus 11202 to display a picked up image in which the surgical region or the like is imaged. Thereupon, the control unit 11413 may recognize various objects in the picked up image using various image recognition technologies. For example, the control unit 11413 can recognize a surgical tool such as forceps, a particular living body region, bleeding, mist when the energy device 11112 is used, and so forth by detecting the shape, color, and so forth of edges of objects included in a picked up image. The control unit 11413 may cause, when it causes the display apparatus 11202 to display a picked up image, various kinds of surgery supporting information to be displayed in an overlapping manner with an image of the surgical region using a result of the recognition. Where surgery supporting information is displayed in an overlapping manner and presented to the surgeon 11131, the burden on the surgeon 11131 can be reduced and the surgeon 11131 can proceed with the surgery with certainty.

The transmission cable 11400 which connects the camera head 11102 and the CCU 11201 to each other is an electric signal cable ready for communication of an electric signal, an optical fiber ready for optical communication, or a composite cable ready for both of electrical and optical communications.

Here, while, in the example illustrated, communication is performed by wired communication using the transmission cable 11400, the communication between the camera head 11102 and the CCU 11201 may be performed by wireless communication.

The example of the endoscopic surgery system to which the technology according to the present disclosure can be applied has been described above. The technology according to the present disclosure can be applied to the image pickup unit 11402 of the camera head 11102 among the above-described configurations. Specifically, the optical device as described above can be used as the image pickup unit 11402. According to the above-described optical device, it is possible to reduce the dead time and save power. Thus, similar effects are exhibited by the endoscopic surgery system to which the optical device is applied.

The technology according to the present disclosure (the present technology) can be applied to various products. For example, the technology according to the present disclosure may be achieved as a device (or a system) mounted on any type of mobile object such as an automobile, an electric vehicle, a hybrid electric vehicle, a motorcycle, a bicycle, a personal mobility, an airplane, a drone, a ship, a robot, and the like.

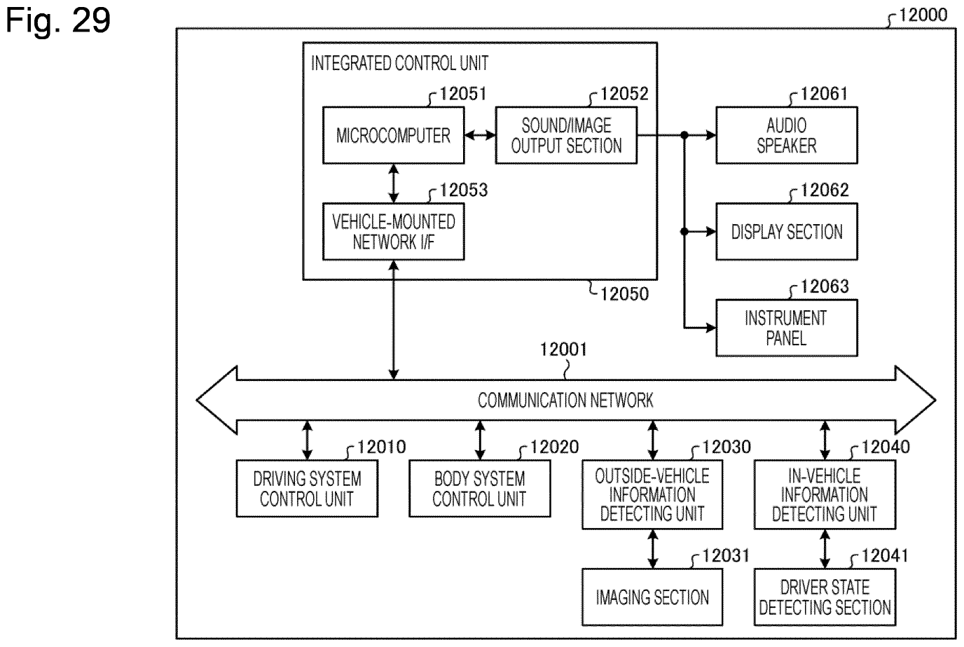

FIG. 29 is a block diagram illustrating a schematic configuration example of a vehicle control system which is an example of a moving body control system to which the technology according to the present disclosure can be applied.

The vehicle control system 12000 includes a plurality of electronic control units connected to each other via a communication network 12001. In the example illustrated in FIG. 29, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying an occupant of the vehicle or the outside of the vehicle of information. In the example of FIG. 29, an audio speaker 12061, a display section 12062, and an instrument panel 12063 are illustrated as the output device. The display section 12062 may, for example, include at least one of an on-board display or a head-up display.

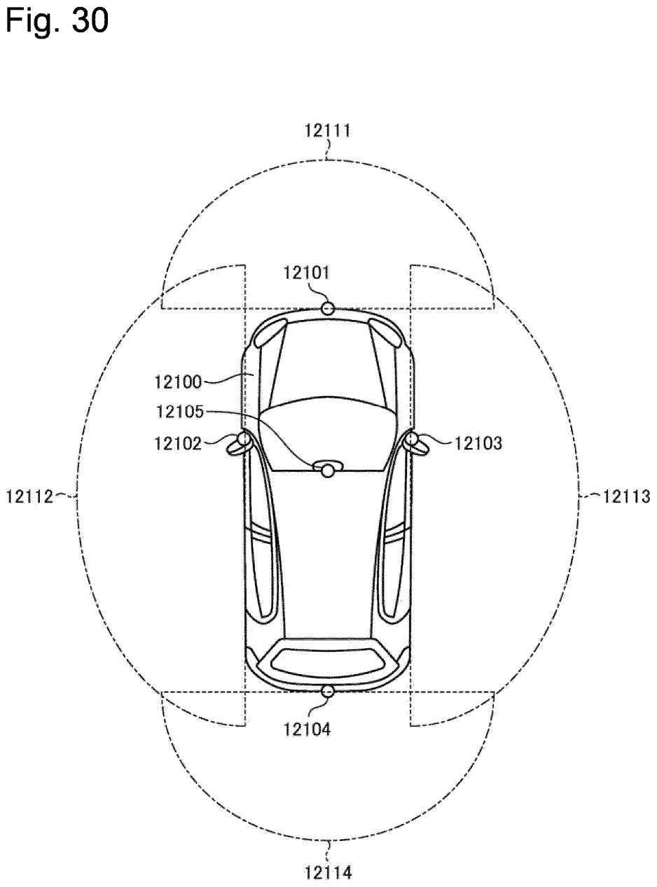

FIG. 30 is a diagram illustrating an example of the installation position of the imaging section 12031.

In FIG. 30, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 30 illustrates an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Moreover, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, and other three-dimensional objects such as a utility pole on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. In addition, the sound/image output section 12052 may also control the display section 12062 so that an icon or the like representing the pedestrian is displayed at a desired position.

The example of the vehicle control system to which the technology according to the present disclosure can be applied has been described above. The technology according to the present disclosure can be applied to the imaging sections 12101 to 12104 among the above-described configurations. Specifically, the imaging element as described above can be applied to the imaging sections 12101 to 12104. By applying the technology according to the present disclosure to the imaging sections 12101 to 12104, for example, a pedestrian can be recognized from slight light from the pedestrian even at night or in a dark place. Further, the effect that the power consumption can be reduced by the technology according to the present disclosure is particularly useful in a vehicle including a driving motor as a driving force generation device for generating a driving force of the vehicle.

Note that, in the above description, various effects exhibited by the optical are described, but such effects do not limit the present disclosure. Further, it is not necessary to exhibit all of the various effects. Further, additional effects not described herein may be exhibited by the light receiving element, the optical device, and the electronic apparatus of the present disclosure.

Note that the present technology can have configurations as follows.
[1] An optical device (10) comprising:
   a plurality of pixels (20) each configured to receive light and perform photoelectric conversion via a single photon avalanche diode, SPAD, to generate an electrical signal;
   circuitry (20a) configured to generate image data from the electrical signals based on imaging parameters that are adjustable for each pixel (20);
   a control unit (30) that is configured to divide for each of a series of specific time periods the plurality of pixels (20) into at least a first subset (S1) of pixels (20) and a second subset (S2) of pixels (20), to set for each specific time period to the pixels (20) of each subset (S1, S2) a different parameter value of at least one of the imaging parameters, and to carry out predetermined processing by using the image data obtained via the at least two subsets (S1, S2) of pixels (20) during the respective specific time period.
[2] The optical device (10) according to 1, wherein
   the control unit (30) is configured to carry out the predetermined processing also based on information about the division of the plurality of pixels (20) into the different subsets (S1, S2) of pixels (20).
[3] The optical device (10) according to 1 or 2, wherein
   the control unit (30) is configured to perform the division of the plurality of pixels (20) into the subsets (S1, S2) of pixels (20) randomly.
[4] The optical device (10) according to 1 or 2, wherein
   the control unit (30) is configured to perform the division of the plurality of pixels (20) into the subsets (S1, S2) of pixels (20) at consecutive points in time based on an evaluation of the outcome of the predetermined processing that was carried out previously.
[5] The optical device (10) according to 4, wherein
   the control unit (30) is configured to change the pixel ratio of the number of pixels (20) in the different subsets (S1, S2) based on the evaluation of the outcome of the predetermined processing that was carried out
[6] The optical device (10) according to 5, wherein
   the control unit (30) is configured to segment the plurality of pixels (20) into different areas based on the evaluation of the outcome of the predetermined processing that was carried out previously, and to divide the pixels (20) in different areas according to different pixel ratios.
[7] The optical device (10) according to any one of 4 to 6, wherein
   the control unit (30) is configured to evaluate the outcome of the predetermined processing that was carried out previously by using a neuronal network.
[8] The optical device (10) according to any one of 1 to 7, wherein
   the control unit (30) is configured to generate during each specific time period predetermined intermediate images (11, 12) for each subset of pixels (S1, S2) by using the image data generated by the pixels (20) of the respective subset (S1, S2) of pixels (20), and to generate final images (F) by fusing intermediate images (11, 12) of different subsets (S1, S2) of pixels (20).
[9] The optical device (10) according to any one of 1 to 8, wherein
   the control unit (30) is configured to carry out the predetermined processing by using an artificial intelligence model that receives the image data obtained via the at least two subsets (S1, S2) of pixels (20) during each specific time period and carries out the predetermined processing based on said image data.
[10] The optical device (10) according to any one of 1 to 9, wherein
   the at least one imaging parameter is one of the photon detection efficiency of the SPAD, an exposure time of the SPAD, a dead time of the SPAD, and a photon counting strategy that defines a periodic change of exposure times of the SPAD.
[11] The optical device (10) according to any one of 1 to 10, further comprising
   a sensor chip (10a) on which the pixels (20) and the circuitry (20a) are arranged; wherein
   the sensor chip (10a) comprises a first port (40a) for outputting the image data from the sensor chip (10a), and a second port (40b) for inputting control information for controlling the division of the plurality of pixels (20) into the subsets (S1, S2) of pixels (20) and the parameter values of the at least one imaging parameter.
[12] The optical device (10) according to any one of 1 to 11, wherein
   the control unit (30) is configured to perform the division of the plurality of pixels (20) into the subsets (S1, S2) of pixels (20) at consecutive points in time and the setting of the parameter values of the imaging parameters based on a first artificial intelligence model;
   the control unit (30) is configured to carry out the predetermined processing based on a second artificial intelligence model; and
   the first artificial intelligence model and the second artificial intelligence model are trained together such as to optimize the predetermined processing and to minimize a data amount of the image data obtained via the at least two subsets (S1, S2) of pixels (20).
[13] A method for operating an optical device (10), the method comprising:
   receiving light and performing photoelectric conversion with a plurality of pixels (20) of the optical device (10) to generate an electrical signal via a single photon avalanche diode, SPAD;
   generating with circuitry (20a) of the optical device (10) image data from the electrical signals based on imaging parameters that are adjustable for each pixel (20);
   dividing for each of a series of specific time periods the plurality of pixels (20) into at least a first subset (S1) of pixels (20) and a second subset (S2) of pixels (20);
   setting for each specific time period to the pixels (20) of each subset (S1, S2) a different parameter value of at least one of the imaging parameters; and
   carrying out predetermined processing by using the image data obtained via the at least two subsets (S1, S2) of pixels (20) during the respective specific time period.
[14] A method of training a combination of a first artificial intelligence model (30a) and a second artificial intelligence model (30b), where the first artificial intelligence model (30a) is used in the method according to 13 to divide the plurality of pixels (20) into the subsets (S1, S2) of pixels (20) at consecutive points in time and to set the parameter values of the imaging parameters and the second artificial intelligence model (30b) is used in the method according to 13 to carry out the predetermined processing, the method comprising
   training the first artificial intelligence model (30a) and the second artificial intelligence model (30b) together such as to optimize the predetermined processing and to minimize a data amount of the image data obtained via the at least two subsets (S1, S2) of pixels (20).

1. An optical device comprising:
a plurality of pixels each configured to receive light and perform photoelectric conversion via a single photon avalanche diode, SPAD, to generate an electrical signal;
circuitry configured to generate image data from the electrical signals based on imaging parameters that are adjustable for each pixel;
a control unit that is configured to divide for each of a series of specific time periods the plurality of pixels into at least a first subset of pixels and a second subset of pixels, to set for each specific time period to the pixels of each subset a different parameter value of at least one of the imaging parameters, and to carry out predetermined processing by using the image data obtained via the at least two subsets of pixels during the respective specific time period.

2. The optical device according to claim 1, wherein
the control unit is configured to carry out the predetermined processing also based on information about the division of the plurality of pixels into the different subsets of pixels.

3. The optical device according to claim 1, wherein
the control unit is configured to perform the division of the plurality of pixels into the subsets of pixels randomly.

4. The optical device according to claim 1, wherein
the control unit is configured to perform the division of the plurality of pixels into the subsets of pixels at consecutive points in time based on an evaluation of the outcome of the predetermined processing that was carried out previously.

5. The optical device according to claim 4, wherein
the control unit is configured to change the pixel ratio of the number of pixels in the different subsets based on the evaluation of the outcome of the predetermined processing that was carried out previously.

6. The optical device according to claim 5, wherein
the control unit is configured to segment the plurality of pixels into different areas based on the evaluation of the outcome of the predetermined processing that was carried out previously, and to divide the pixels in different areas according to different pixel ratios.

7. The optical device according to claim 4, wherein
the control unit is configured to evaluate the outcome of the predetermined processing that was carried out previously by using a neuronal network.

8. The optical device according to claim 1, wherein
the control unit is configured to generate during each specific time period predetermined intermediate images for each subset of pixels by using the image data generated by the pixels of the respective subset of pixels, and to generate final images by fusing intermediate images of different subsets of pixels.

9. The optical device according to claim 1, wherein
the control unit is configured to carry out the predetermined processing by using an artificial intelligence model that receives the image data obtained via the at least two subsets of pixels during each specific time period and carries out the predetermined processing based on said image data.

10. The optical device according to claim 1, wherein
the at least one imaging parameter is one of the photon detection efficiency of the SPAD, an exposure time of the SPAD, a dead time of the SPAD, and a photon counting strategy that defines a periodic change of exposure times of the SPAD.

11. The optical device according to claim 1, further comprising
a sensor chip on which the pixels and the circuitry are arranged; wherein
the sensor chip comprises a first port for outputting the image data from the sensor chip, and a second port for inputting control information for controlling the division of the plurality of pixels into the subset of pixels and the parameter values of the at least one imaging parameter.

12. The optical device according to claim 1, wherein
the control unit is configured to perform the division of the plurality of pixels into the subsets of pixels at consecutive points in time and the setting of the parameter values of the imaging parameters based on a first artificial intelligence model;
the control unit is configured to carry out the predetermined processing based on a second artificial intelligence model; and
the first artificial intelligence model and the second artificial intelligence model are trained together such as to optimize the predetermined processing and to minimize a data amount of the image data obtained via the at least two subsets of pixels.

13. A method for operating an optical device, the method comprising:
receiving light and performing photoelectric conversion with a plurality of pixels of the optical device to generate an electrical signal via a single photon avalanche diode, SPAD;
generating with circuitry of the optical device image data from the electrical signals based on imaging parameters that are adjustable for each pixel;
dividing for each of a series of specific time periods the plurality of pixels into at least a first subset of pixels and a second subset of pixels;
setting for each specific time period to the pixels of each subset a different parameter value of at least one of the imaging parameters; and
carrying out predetermined processing by using the image data obtained via the at least two subsets of pixels during the respective specific time period.

14. A method of training a combination of a first artificial intelligence model and a second artificial intelligence model, where the first artificial intelligence model is used in the method according to claim 13 to divide the plurality of pixels into the subsets of pixels at consecutive points in time and to set the parameter values of the imaging parameters and the second artificial intelligence model is used in the method according to claim 13 to carry out the predetermined processing, the method comprising
training the first artificial intelligence model and the second artificial intelligence model together such as to optimize the predetermined processing and to minimize a data amount of the image data obtained via the at least two subsets of pixels.
